(19) United States
(12) Patent Application Publication
(10) Pub. No.: US 2026/0136262 A1
(43) Pub. Date: May 14, 2026

(54) METHOD AND APPARATUS FOR PERFORMING HANDOVER IN NON-TERRESTRIAL NETWORK COMMUNICATION SYSTEM

(71) Applicant: Samsung Electronics Co., Ltd., Suwon-si (KR)

(72) Inventors: Sunhyun KIM, Suwon-si (KR); Sangho LEE, Suwon-si (KR); Dongmyung KIM, Suwon-si (KR); Daeun KO, Suwon-si (KR)

(21) Appl. No.: 19/388,043

(22) Filed: Nov. 13, 2025

(30) Foreign Application Priority Data
Nov. 13, 2024 (KR) 10-2024-0161335

(51) Int. Cl. H04W 36/32; H04B 17/318; H04W 36/00; H04W 64/00

(52) U.S. Cl. CPC H04W 36/322; H04B 17/328; H04W 36/0058; H04W 64/00

(57) ABSTRACT

5^{th} generation (5G) or 6^{th} generation (6G) communication systems for supporting a higher data transmission rate than beyond 4^{th} generation (4G) communication systems, such as long-term evolution (LTE), are provided. A user equipment (UE) is provided. The UE includes determining whether a position of the UE related to a movement direction of a satellite within a serving cell and a neighbor cell is a satellite directional cell center area or a satellite directional cell edge area, and configuring handover-related parameters, based on the determined position of the UE related to the movement direction of the satellite within the serving cell and the neighbor cell.

### CROSS-REFERENCE TO RELATED APPLICATION(S)

This application is based on and claims priority under 35 U.S.C. § 119(a) of a Korean patent application number 10-2024-0161335, filed on Nov. 13, 2024, in the Korean Intellectual Property Office, the disclosure of which is incorporated by reference herein in its entirety.

### BACKGROUND

### 1. Field

The disclosure relates to a non-terrestrial network (NTN) communication system. More particularly, the disclosure relates to a method and apparatus for performing handover by taking into account a movement direction of a satellite so as to improve communication performance of an NTN user equipment (UE).

### 2. Description of Related Art

Considering the development of wireless communication from generation to generation, technologies have been developed mainly for services targeting humans, such as voice calls, multimedia services, data services, or the like. Connected devices, which are on an exponential increase after the commercialization of 5^{th} generation (5G) communication systems, are expected to be connected to communication networks. Examples of things connected to the network may include vehicles, robots, drones, home appliances, displays, smart sensors installed in various infrastructures, construction machines, and factory equipment. Mobile devices are expected to evolve into various form factors, such as augmented reality glasses, virtual reality headsets, and hologram devices. In the 6^{th} generation (6G) era, efforts are being made to develop improved 6G communication systems in order to provide various services by connecting hundreds of billions of devices and things. For this reason, 6G communication systems are referred to as beyond 5G systems.

In a 6G communication system that is predicted to be commercialized around 2030, a maximum data rate is tera (that is, 1,000 giga) bps, and a radio latency is 100 microseconds (usec). That is, the 6G communication system will be 50 times as fast as 5G communication system and have 1/10 the radio latency thereof.

To achieve a high data rate and ultra low latency, the implementation of 6G communication systems in a terahertz band (e.g., a band of 95 GHz to 3 THz) is under consideration. In the terahertz band, path loss and atmospheric absorption are serious, compared with a millimeter wave (mm Wave) band introduced in 5G. Therefore, it is expected that the importance of technology capable of ensuring signal propagation distances (i.e., coverage) will increase. As the main technologies for securing the coverage, radio frequency (RF) elements, antennas, new waveforms which have better coverage than orthogonal frequency division multiplexing (OFDM), beamforming, and multiple antenna transmission technologies, such as multiple-input and multiple-output (MIMO), full dimensional MIMO (FD-MIMO), array antenna, and large scale antenna need to be developed. In addition, to improve the coverage of terahertz band signals, new technologies, such as metamaterial-based lenses and antennas, high-dimensional spatial multiplexing technology using orbital angular momentum (OAM), and reconfigurable intelligent surface (RIS), are being discussed.

Also, to improve frequency efficiency and system network, a full duplex technology for enabling uplink transmission and downlink transmission to use the same frequency resource at the same time, a network technology that integrates satellite and high-altitude platform stations (HAPS), etc., a network structure innovation technology that supports mobile base stations, etc. and enables network operation optimization, automation, etc., a dynamic spectrum sharing technology for collision avoidance based on spectrum usage prediction, an artificial intelligence (AI)-based communication technology that utilizes AI from a design stage and internalizes an end-to-end AI support function to realize system optimization, and a next-generation distributed computing technology that realizes services of complexity exceeding the limits of terminal computational capability by using ultra-high-performance communication and computing resources (mobile edge computing (MEC), cloud, etc.) are being developed in a 6G communication system. In addition, attempts to further strengthen connectivity between devices, further optimize networks, accelerate softwarization of network entities, and increase the openness of wireless communications are continuously made through the design of new protocols to be used in 6G communication systems, the implementation of hardware-based security environments, the development of mechanisms for the safe use of data, and the development of technologies on how to maintain privacy.

Due to the research and development of such 6G communication systems, it is expected that the next hyper-connected experience will become possible through the hyper-connectivity of the 6G communication system that includes not only the connection between things but also the connection between people and things. Specifically, it is expected that services, such as true immersive extended reality (XR), high-fidelity mobile hologram, and digital replica, will be provided through 6G communication systems. Also, because services such as remote surgery, industrial automation, and emergency response through security and reliability enhancement are provided through 6G communication systems, these services will be applied in various fields, such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for performing handover by taking into account a movement direction of a satellite so as to improve communication performance of an NTN user equipment (UE).

Additional aspects will be set forth in part in the description which follows and, in part, will be apparent from the description, or may be learned by practice of the presented embodiments.

In accordance with an aspect of the disclosure, a method performed by a user equipment (UE) in a non-terrestrial network (NTN) communication system is provided. The method includes determining whether a position of the UE related to a movement direction of a satellite within a serving cell and a neighbor cell is a satellite directional cell center area or a satellite directional cell edge area, and configuring handover-related parameters, based on the determined position of the UE related to the movement direction of the satellite within the serving cell and the neighbor cell.

In accordance with an aspect of the disclosure, a method performed by a base station in a non-terrestrial network (NTN) system is provided. The method includes broadcasting, to a user equipment (UE), system information including distance threshold information, wherein the distance threshold information indicates a distance criterion that distinguishes between a satellite directional cell center area and a satellite directional cell edge area, and a position of the UE related to a movement direction of a satellite within the serving cell and the neighbor cell is determined, based on the distance threshold information, transmitting, to the UE, measurement configuration information including handover-related parameters associated with the position of the UE related to the movement direction of the satellite within the serving cell and the neighbor cell, wherein the handover-related parameters are configured, based on the measurement configuration information and the determined position of the UE related to the movement direction of the satellite within the serving cell and the neighbor cell, and receiving a measurement report message from the UE, based on the configured handover-related parameters.

In accordance with an aspect of the disclosure, a user equipment (UE) in a non-terrestrial network (NTN) system is provided. The UE includes memory storing one or more instructions and at least one processor communicatively coupled to the memory, wherein the one or more instructions, when executed by the at least one processor individually or collectively, cause the UE to determine whether a position of the UE related to a movement direction of a satellite within a serving cell and a neighbor cell is a satellite directional cell center area or a satellite directional cell edge area, and configure handover-related parameters, based on the determined position of the UE related to the movement direction of the satellite within the serving cell and the neighbor cell.

In accordance with an aspect of the disclosure, a base station in a non-terrestrial network (NTN) system is provided. The base station includes memory storing one or more instructions and at least one processor communicatively coupled to the memory, wherein the one or more instructions, when executed by at least one processor individually or collectively, cause the base station to broadcast, to a user equipment (UE), system information including distance threshold information, indicates a distance criterion that distinguishes between a satellite directional cell center area and a satellite directional cell edge area, and a position of the UE related to a movement direction of a satellite within the serving cell and the neighbor cell is determined, based on the distance threshold information, transmit, to the UE, measurement configuration information including handover-related parameters associated with the position of the UE related to the movement direction of the satellite within the serving cell and the neighbor cell, wherein the handover-related parameters is configured, based on the measurement configuration information and the determined position of the UE related to the movement direction of the satellite within the serving cell and the neighbor cell, and receive a measurement report message from the UE, based on the configured handover-related parameters.

In accordance with an aspect of the disclosure, one or more non-transitory computer-readable recording media storing one or more computer programs including computer-executable instructions, when executed by one or more processors of a user equipment (UE) in a non-terrestrial network (NTN) system individually or collectively, cause the UE to perform operations are provided. The operations include determining whether a position of the UE related to a movement direction of a satellite within a serving cell and a neighbor cell is a satellite directional cell center area or a satellite directional cell edge area, and configuring handover-related parameters, based on the determined position of the UE related to the movement direction of the satellite within the serving cell and the neighbor cell.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing the technical field and purposes of the disclosure according to an embodiment of the disclosure;

FIG. 2A is a diagram for describing an earth moving cell operation method of a low earth orbit (LEO) satellite in a non-terrestrial network (NTN) communication system according to an embodiment of the disclosure;

FIG. 2B is a diagram for describing a quasi-earth fixed cell operation method of an LEO satellite in an NTN communication system according to an embodiment of the disclosure;

FIG. 3A is a diagram for describing a quasi-earth fixed cell operation method of an LEO satellite using a phased array antenna in an NTN communication system according to an embodiment of the disclosure;

FIG. 3B is a diagram for describing an example of a beam codebook of an LEO satellite using a phased array antenna in an NTN communication system according to an embodiment of the disclosure;

FIG. 4A is a diagram for describing a received signal change characteristic of a user equipment (UE) when the UE is located at a center of a quasi-earth fixed cell in an NTN communication system according to an embodiment of the disclosure;

FIG. 4B is a diagram for describing a received signal change characteristic of a UE when the UE is located at an edge of a quasi-earth fixed cell in an NTN communication system according to an embodiment of the disclosure;

FIGS. 4C and 4D are diagrams for describing a received signal change characteristic simulation result according to a position of a UE within a quasi-earth fixed cell in an NTN communication system according to various embodiments of the disclosure;

FIG. 5A is a diagram for describing the definition of a satellite directional cell center area and a satellite directional cell edge area within a quasi-earth fixed cell in an NTN communication system according to an embodiment of the disclosure;

FIG. 5B is a diagram for describing examples of handover scenarios that take into account a position of a UE within a quasi-earth fixed cell related to a movement direction of a satellite in an NTN communication system according to an embodiment of the disclosure;

FIG. 6A is a diagram for described a reference signal received power (RSRP)-based handover mechanism in a wireless communication system according to an embodiment of the disclosure;

FIG. 6B is a diagram for described a distance-based handover mechanism in an NTN communication system according to an embodiment of the disclosure;

FIGS. 7A and 7B are diagrams for describing examples of appropriate handover control for each handover scenario that takes into account a movement direction of a satellite in an NTN communication system according to various embodiments of the disclosure;

FIG. 8 is a diagram for describing a method, performed by a UE and a base station, of performing handover by taking into account a movement direction of a satellite in an NTN communication system according to an embodiment of the disclosure;

FIG. 9A is a flowchart of a method, performed by a UE and a base station, of differentially configuring handover-related parameters associated with a position of the UE related to a movement direction of a satellite, based on distance threshold information, in an NTN communication system according to an embodiment of the disclosure;

FIG. 9B is a diagram for describing a method, performed by a UE, of determining a position of the UE within a cell related to a movement direction of a satellite, based on distance threshold information, in an NTN communication system according to an embodiment of the disclosure;

FIG. 10A is a flowchart of a method, performed by a UE and a base station, of differentially configuring handover-related parameters associated with a position of the UE related to a movement direction of a satellite, based on repetitive specific RSRP pattern information, in an NTN communication system according to an embodiment of the disclosure;

FIG. 10B is a diagram for describing a method, performed by a UE, of determining a position of the UE within a cell related to a movement direction of a satellite, based on repetitive specific RSRP pattern information, in an NTN communication system according to an embodiment of the disclosure;

FIG. 11 is a diagram for describing a method, performed by a UE and a base station, of performing handover by differentially applying handover-related parameters associated with a position of the UE related to a movement direction of a satellite in an NTN communication system according to an embodiment of the disclosure;

FIG. 12A is a diagram for describing an example of a method, performed by a base station, of transmitting, to a UE, handover-related parameters associated with a position of the UE related to a movement direction of a satellite by using event identifier (ID) information associated with RSRP-based handover in an NTN communication system according to an embodiment of the disclosure;

FIG. 12B is a diagram for describing an example of an RSRP-based handover mechanism that utilizes event ID information associated with RSRP-based handover for each handover scenario that takes into account a movement direction of a satellite in an NTN communication system according to an embodiment of the disclosure;

FIG. 12C is a diagram for describing an example of a method, performed by a UE, of differentially configuring RSRP-based handover-related parameters associated with a position of the UE related to a movement direction of a satellite in an NTN communication system according to an embodiment of the disclosure;

FIG. 13A is a diagram for describing an example of a method, performed by a base station, of transmitting, to a UE, handover-related parameters associated with a position of the UE related to a movement direction of a satellite by using event ID information associated with distance-based handover in an NTN communication system according to an embodiment of the disclosure;

FIG. 13B is a diagram for describing an example of a distance-based handover mechanism that utilizes event ID information associated with distance-based handover for each handover scenario that takes into account a movement direction of a satellite in an NTN communication system according to an embodiment of the disclosure;

FIG. 13C is a diagram for describing an example of a method, performed by a UE, of differentially configuring distance-based handover-related parameters associated with a position of the UE related to a movement direction of a satellite in an NTN communication system according to an embodiment of the disclosure;

FIG. 14 is a diagram for describing an example of a method, performed by a UE, of differentially configuring handover-related parameters associated with a position of the UE related to a movement direction of a satellite, according to the UE's own implementation, in an NTN communication system according to an embodiment of the disclosure;

FIGS. 15A and 15B are diagrams for describing an example of a method, performed by a UE, of performing handover by taking into account a movement direction of a satellite, when a satellite is changed, in an NTN communication system according to various embodiments of the disclosure;

FIG. 16 is a diagram for describing a method, performed by a UE, of performing handover by taking into account a movement direction of a satellite in an NTN communication system according to an embodiment of the disclosure;

FIG. 17 is a diagram for describing a method, performed by a base station, of performing handover by taking into account a movement direction of a satellite in an NTN communication system according to an embodiment of the disclosure;

FIG. 18 is a block diagram of a UE according to an embodiment of the disclosure; and

FIG. 19 is a block diagram of a base station according to an embodiment of the disclosure.

Throughout the drawings, it should be noted that like reference numbers are used to depict the same or similar elements, features, and structures.

### DETAILED DESCRIPTION

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Herein, it will be understood that each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “˜unit” may refer to a software element or a hardware element, such as a field programmable gate array (FPGA) or an application specific integrated circuit (ASIC), which performs a predetermined function. However, the term including the word “˜unit” does not always have a meaning limited to software or hardware. The “˜unit” may be constructed either to be stored in an addressable storage medium or to execute one or more processors. Therefore, the “˜unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into additional components and a “˜unit.” Moreover, the components and “˜units” may be implemented to reproduce one or more central processing units (CPUs) within a device or a security multimedia card. Further, in the embodiments, the “unit” may include one or more processors.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

Hereinafter, the determination of priority between A and B in the present disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the present disclosure may be understood as “A and/or B,” which may include A, or B, or both A and B.

In addition, “at least one of A, B, and C” as described in the present disclosure may be understood to include A, or B, or C, or any combination of A, B, and C.

In addition, “at least one of A, B, or C” as described in the present disclosure may be understood to include A, or B, or C, or any combination of A, B, and C.

Furthermore, “A/B” as described in the present disclosure may be understood as “A and/or B,” which may include A, or B, or both A and B.

Furthermore, “A, B” as described in the present disclosure may be understood as “A and/or B,” which may include A, or B, or both A and B.

Furthermore, “A and B” as described in the present disclosure may be understood as “A and/or B,” which may include A, or B, or both A and B.

Furthermore, “if condition A and condition B are satisfied,” as described in the present disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ˜”, “second ˜”, etc., as described in the present disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ˜” and “second ˜” are described in the present disclosure, it may be understood that element(s) referred to by “first ˜” and “second ˜” may be the same or different. For example, in case of element(s) being information, first information and second information may both be same information and, in some cases, are separate and different information.

In addition, the terms “if ˜” and “in case that ˜” as used in the disclosure or claims may be interpreted to include the meanings of “when (or upon) ˜,” “in response to ˜,” “based on ˜,” or “according to ˜,” and may be used interchangeably with these expressions. In addition, expressions other than those exemplified herein may also be used, as long as they have substantially the same meaning and do not impair the technical features of the present disclosure.

For example, the physical layer signaling may be referred to as Layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as L3 (layer 3) signaling. It should be noted, however, that the higher layer signaling is not limited to the aforementioned examples.

In addition, the term “not perform” as used in the present disclosure or claims may, in context, be understood to mean that the corresponding step is omitted or skipped. Such a term may be replaced with other terms having the same or substantially equivalent meaning.

In addition, “transmitting a message including A and B” as described in the present disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the present disclosure described below, terms or components included in the disclosure may be expressed in singular or plural form depending on the specific embodiments presented. However, such singular or plural expressions are selected appropriately for convenience of description, and the present disclosure is not limited to a singular or plural number of components. A component expressed in the plural form may be implemented as a single component, and a component expressed in the singular form may be implemented as multiple components.

The drawings or flowcharts described below illustrate exemplary methods that may be implemented according to the principles of the present disclosure, and various modifications may be made to the methods illustrated in the flowcharts of the present disclosure. For example, although illustrated as a series of steps, various steps in each drawing or flowchart may overlap, occur in parallel, occur in a different order, or be repeated. In other examples, any step may be omitted or replaced with another step.

The methods and apparatuses proposed in the embodiments of the present disclosure are not limited to each embodiment individually, but may also be applied in combination of all or some of the embodiments proposed in the disclosure. Therefore, the embodiments of the present disclosure may be modified and applied without significantly departing from the scope of the present disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B”, such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the present disclosure is not limited to the terms described below, and other terms having equivalent technical meanings may also be used. Such terms may also be interchangeable with terms defined in any 3rd generation partnership project (3GPP) technical specifications (TS) where appropriate.

Hereinafter, a base station is an entity that allocates resources to terminals, and may be at least one of a gNode B, an eNode B, a Node B, a base station (BS), a wireless access unit, a BS controller, or a node on a network.

Furthermore, the base station of the present disclosure may include a split architecture comprising a central unit (CU) and a distributed unit (DU). In this structure, the CU is configured to process the higher layers of the control and user planes, while the DU is configured to process lower-layer radio resource functions. The embodiments of the present disclosure may be equally applicable to 5G base station architectures in which such CU and DU functional splits are implemented.

A terminal may include a UE, a mobile station (MS), a cellular phone, a smartphone, a computer, or a multimedia system capable of performing communication functions.

In the disclosure, a downlink (DL) refers to a radio link through which a BS transmits a signal to a UE, and an uplink (UL) refers to a radio link through which a UE transmits a signal to a BS.

Furthermore, hereinafter, 5th generation (5G) mobile communication technologies (e.g., 5G new radio (NR)), 6th generation (6G) mobile communication technologies may be described by way of example, but the embodiments of the present disclosure may also be applied to other communication systems having similar technical backgrounds or channel types. For example, newly evolved mobile communication systems developed after 5G and 6G may be included. Furthermore, based on determinations by those skilled in the art, the embodiments of the present disclosure may also be applied to other communication systems (e.g., Wi-Fi systems) through some modifications without significantly departing from the scope of the present disclosure

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, in the present disclosure, the expression “transmit a physical channel” may be interpreted as being equivalent to the expression “transmit data or a signal via a physical channel.”

Hereinafter, in the context of the present disclosure, higher layer signaling may refer to signaling corresponding to at least one or any combination of the following: master information block (MIB), system information block (SIB) or SIB M (M=1, 2, . . . ), radio resource control (RRC), or medium access control (MAC) control element (CE), or a non-access stratum (NAS) signaling message, or an application layer message. The RRC signaling message may be referred to as L3 (layer 3) signaling.

In addition, L1 signaling may refer to signaling corresponding to at least one or any combination of signaling techniques using the at least one or any combination of the following physical layer channels or signaling: physical downlink control channel (PDCCH), downlink control information (DCI), user equipment (UE)-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression that information is configured by the BS, as used in the present disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the present disclosure will be described in detail with reference to the accompanying drawings.

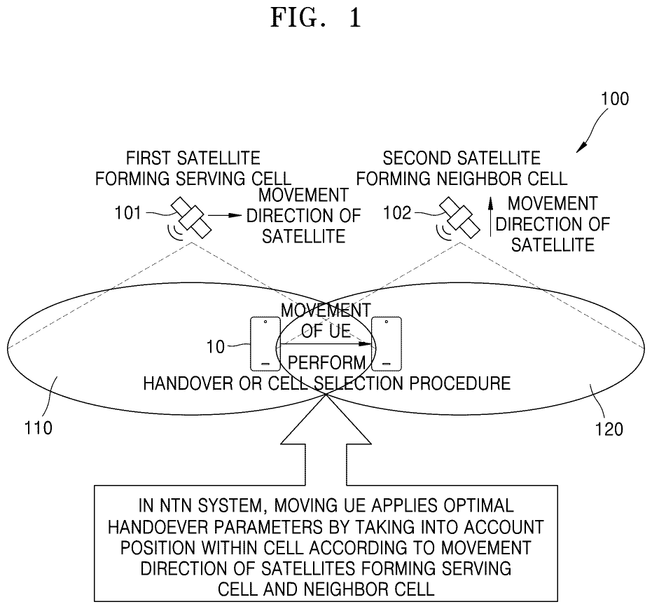

As the description allows for various changes and numerous embodiments of the disclosure, certain embodiments of the disclosure will be illustrated in the drawings and described in detail in the written description. However, FIGS. 1, 2A, 2B, 3A, 3B. 4A to 4D, 5A, 5B, 6A, 6B, 7A, 7B, 8, 9A, 9B, 10A, 10B, 11, 12A to 12C, 13A to 13C, 14, 15A, 15B, and 16 to 19 discussed below and various embodiments of the disclosure used to explain the principles of the disclosure in the present specification are merely examples and should not be construed as limiting the scope of the disclosure in any way. It will be understood by those of ordinary skill in the art that the principles of the disclosure may be implemented in any suitably arranged system or device. Furthermore, it will be understood by those of ordinary skill in the art that the principles of the disclosure may be implemented in any suitably configured wireless communication system.

For the same reason, some elements in the accompanying drawings are exaggerated, omitted, or schematically illustrated. Also, the size of each element does not entirely reflect the actual size. The same reference numerals are assigned to the same or corresponding elements in the drawings.

It will be understood that the respective blocks of flowcharts and combinations of the flowcharts may be performed by computer program instructions. Because these computer program instructions may be embedded in a processor of a generic-purpose computer, a special-purpose computer, or other programmable data processing apparatuses, the instructions to be executed through the processor of the computer or other programmable data processing apparatus generate modules for performing the functions described in the flowchart block(s). Because these computer program instructions may also be stored in a computer-executable or computer-readable memory that may direct the computer or other programmable data processing apparatus so as to implement functions in a particular manner, the instructions stored in the computer-executable or computer-readable memory are also capable of producing an article of manufacture containing instruction modules for performing the functions described in the flowchart block(s). Because the computer program instructions may also be embedded in the computer or other programmable data processing apparatus, the instructions for executing the computer or other programmable data processing apparatuses by generating a computer-implemented process by performing a series of operations on the computer or other programmable data processing apparatuses may provide operations for executing the functions described in the flowchart block(s).

Also, each block may represent part of a module, segment, or code that includes one or more executable instructions for executing a specified logical function(s). It should also be noted that, in some alternative implementations, the functions described in the blocks may occur out of the order noted in the drawings. For example, two blocks illustrated in succession may in fact be executed substantially concurrently, or the blocks may sometimes be executed in a reverse order, depending on the functions involved therein.

The term “ . . . er/or” as used herein refers to a software element or a hardware element such as field programmable gate array (FPGA) or application specific integrated circuit (ASIC), and the “ . . . er/or” performs certain functions. However, the term “ . . . er/or” is not limited to software or hardware. The term “ . . . er/or” may be configured in an addressable storage medium or may be configured to reproduce one or more processors. Therefore, for example, the term “ . . . er/or” includes elements, such as software elements, object-oriented software elements, class elements, and task elements, processes, functions, attributes, procedures, subroutines, segments of program code, drivers, firmware, microcodes, circuits, data, databases, data structures, tables, arrays, and variables. Functions provided in the elements and the “ . . . ers/ors” may be combined with fewer elements and “ . . . ers/ors” or may be separated into additional elements and “ . . . ers/ors.” Furthermore, the elements and the “ . . . ers/ors” may be implemented to reproduce one or more central processing units (CPUs) in the device or secure multimedia card. Also, in an embodiment of the disclosure, the “ . . . er/or” may include one or more processors.

The term referring to broadcast information, the term referring to control information, the term related to a communication coverage, the term referring to a state change (e.g., events), and the term referring to network entities, the term referring to messages, the terms referring to elements of a device, etc. as used herein are exemplified for convenience of description. Therefore, the inventive concept is not limited to the terms to be described below, and other terms referring to an equivalent technical meaning may be used.

Hereinafter, for convenience of explanation, terms and names defined in the LTE and NR standards, which are the most recent standards defined by the 3rd Generation Partnership Project (3GPP) organization among the currently existing communication standards are used herein. However, the disclosure is not limited by the terms and names and may be equally applied to systems conforming to other standards.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

FIG. 1 is a diagram for describing the technical field and purposes of the disclosure according to an embodiment of the disclosure.

The disclosure relates to a non-terrestrial network (NTN). The NTN is a technology that utilizes satellites as relays so as to establish communication areas in areas where it is physically or economically impossible to install base stations for mobile communications. A satellite may form satellite coverage on the ground through a plurality of beams, and one beam may correspond to one cell in a terrestrial network. The UE may transmit and receive data to and from the satellite through a cell formed by the satellite.

Referring to FIG. 1, an NTN communication system 100 may include not only an NTN using an LTE standard, an NTN using an NR standard including a function for improving NTN performance, but also an NTN using a 6G standard and expected to be commercialized in 2030, and may include a mobile communication system, a satellite system, a system with a combination of a mobile communication and a satellite system, etc., so as to support an NTN.

The NTN communication system 100 may include a first satellite 101 forming a serving cell 110, a second satellite 102 forming a neighbor cell 120, the serving cell 110, the neighbor cell 120, and a UE 10. The first satellite 101 and the second satellite 102 may be the same satellite or different satellites. The first satellite 101 and the second satellite 102 may continuously move in a specific direction related to the ground while forming the serving cell 110 or the neighbor cell 120 on the ground through a beam.

When the UE 10 moves in the NTN communication system 100, the UE 10 may perform a handover or cell selection procedure from the serving cell 110 formed by the first satellite 101 to the neighbor cell 120 formed by the second satellite 102.

Unlike a terrestrial network, in the NTN communication system 100, the centers of the beams of the first satellite 101 and the second satellite 102 that actually form cells move, and accordingly, UEs at the edges of the serving cell 110 and the neighbor cell 120 experience performance degradation during handover according to a positional relationship within each cell based on the movement direction of the first satellite 101 and the second satellite 102. When the same handover mechanism as in the existing terrestrial network is used without considering these characteristics during handover of the UE 10 in the NTN communication system 100, the UE 10 may be handed over to a cell with poor communication performance, which may lead to a failure in mobility management of the UE 10 and a degradation in communication performance.

The purpose of the disclosure is to improve communication performance (throughput, latency, handover failure ratio, etc.) of the UE 10 and improve user quality of service (QoS) by allowing the UE 10 to select optimal handover parameters for each situation while taking into account the position of the UE 10 within the serving cell 110 and the neighbor cell 120 according to the movement direction of the first satellite 101 and the second satellite 102 when the UE 10 performs the handover or cell selection procedure in the NTN communication system 100. In addition, the disclosure may be commonly applied to various 3GPP mobile communication protocols that are being applied or are scheduled to be applied to NTN.

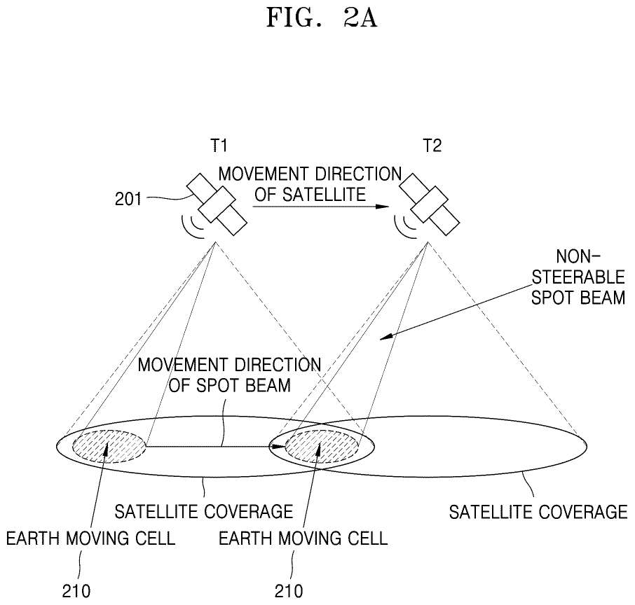

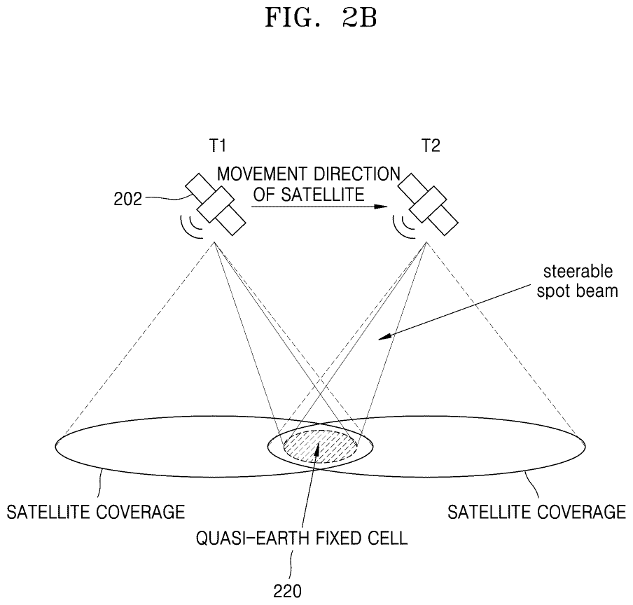

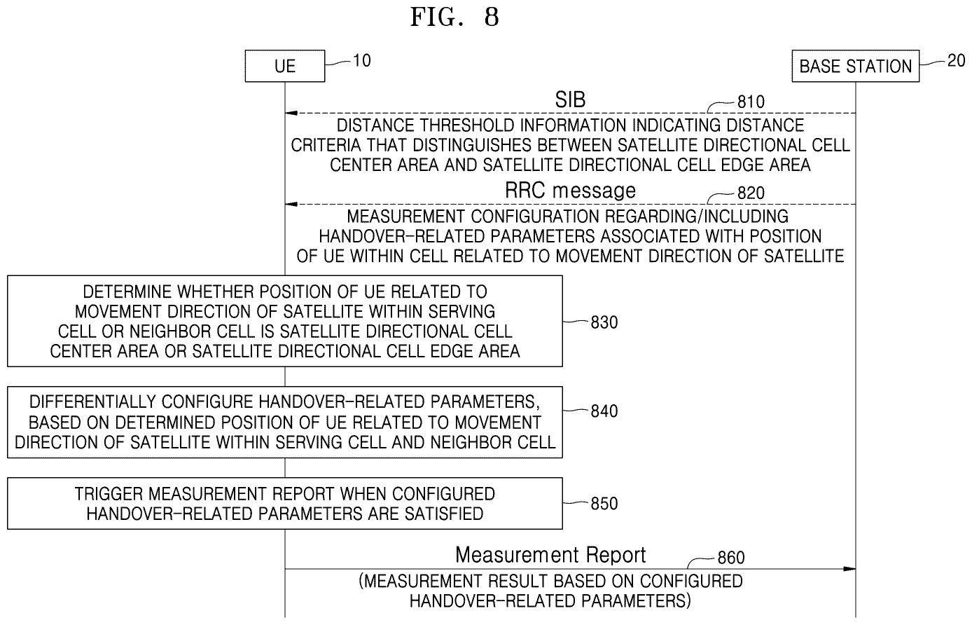

Hereinafter, the motivation, necessity, and purpose of the disclosure will be described in more detail with reference to FIGS. 2A, 2B, 3A, 3B, 4A to 4D, 5A, 5B, 6A, 6B, 7A, and 7B, and specific proposals for achieving the objective of the disclosure will be described in detail with reference to FIGS. 8, 9A, 9B, 10A, 10B, 11, 12A to 12C, 13A to 13C, 14, 15A, 15B, and 16 to 19.

Prior to the description of FIGS. 2A and 2B, the satellites used for NTN communication are briefly described. The satellites for NTN communications may be classified into low earth orbit (LEO), medium earth orbit (MEO), and geostationary earth orbit (GEO) satellites depending on satellite orbits. In general, the GEO satellites may refer to satellites with an altitude of about 36,000 km, the MEO satellites may refer to satellites with an altitude of 5,000 km to 15,000 km, and the LEO satellites may refer to satellites with an altitude of 500 km to 1,000 km. The Earth's orbital period varies depending on the altitude. In the case of the GEO satellites, the Earth's orbital period is about 24 hours. In the case of the MEO satellites, the Earth's orbital period is about 6 hours. In the case of the LEO satellites, the Earth's orbital period is about 90 minutes to about 120 minutes.

Because the LEO satellites are present at a low altitude (200 km to 2000 km), the NTN using the LEO satellites has the advantage of low latency due to short radio round-trip time. However, because the speed is very fast (about 7.56 km/s at 600 km altitude), the NTN using the LEO satellites has the characteristic of constantly changing frequency and/or time synchronization at the UE on the ground. A key technology in NTN is a technology to calculate and compensate for changes in frequency and/or time synchronization due to the mobility of the satellites.

Cell operation methods of the NTN using LEO satellites include 1) an earth moving cell operation method and 2) a quasi-earth fixed cell operation method. The earth moving cell operation method and the quasi-earth fixed cell operation method are useful cell operation methods when forming a satellite cell in a satellite where satellite orbital period is not the same as the Earth's rotation period, like LEO satellites. Hereinafter, the cell operation methods are described with reference to FIGS. 2A and 2B.

FIG. 2A is a diagram for describing a earth moving cell operation method of an LEO satellite in an NTN communication system according to an embodiment of the disclosure.

The earth moving cell operation method is an operation method in which a cell moves along with movement of a satellite when an antenna forming a beam of an LEO satellite is non-steerable.

Referring to FIG. 2A, when an antenna forming a beam of an LEO satellite 201 is a non-steerable antenna, the LEO satellite 201 forms a cell on the ground through a non-steerable spot beam. This cell is referred to as an earth moving cell 210. Even when the LEO satellite 201 moves to the right during the time point T1→T2, the earth moving cell 210 moves to the right together with the LEO satellite 201 because the antenna forming the beam of the LEO satellite 201 is non-steerable.

FIG. 2B is a diagram for describing a quasi-earth fixed cell operation method of an LEO satellite in an NTN communication system according to an embodiment of the disclosure. The quasi-earth fixed cell operation method is an operation method that forms a cell in a certain area of the Earth's surface.

Referring to FIG. 2B, when an antenna forming a beam of an LEO satellite 202 is a non-steerable antenna, the LEO satellite 202 forms a cell on the ground through a steerable spot beam. This cell is referred to as a quasi-earth fixed cell 220. When the LEO satellite 202 moves to the right during the time point T1→T2, the LEO satellite 202 forms the quasi-earth fixed cell 220 in a certain area on the ground by steering the antenna forming the beam. When the quasi-earth fixed cell 220 is present at a position greater than a maximum antenna steering angle due to the movement of the LEO satellite 202 and the LEO satellite 202 is unable to form the quasi-earth fixed cell 220, another satellite in the vicinity is handed over and forms the quasi-earth fixed cell 220.

In the earth moving cell operation method, as the LEO satellite 201 moves, the satellite cell moves along the ground area. Accordingly, the frequency of handover of the UE is high, which may result in unstable connectivity and communication delay and may make it difficult to manage the network. On the other hand, the quasi-earth fixed cell operation method may continuously cover the cell formed in a fixed area on the ground even when the LEO satellite 202 moves. Accordingly, a stable connection may be maintained with a low frequency of handover of the UE, and network management may also be performed efficiently.

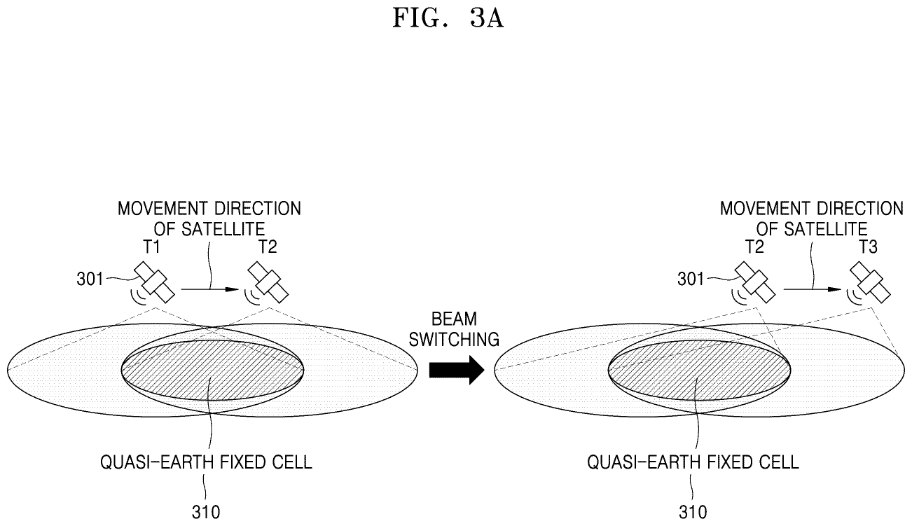

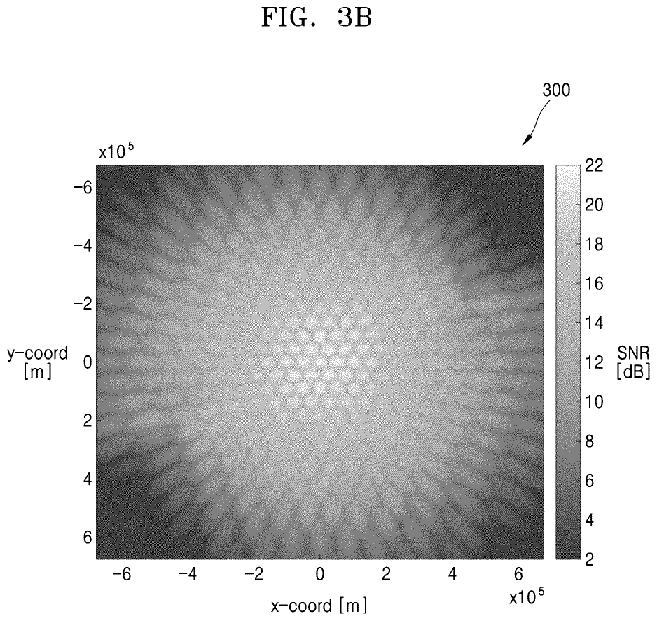

Accordingly, the latest standard-based NTN services, including a 3GPP LTE NTN standard and an NR NTN standard, adopt the quasi-earth fixed cell operation method. Hereinafter, a quasi-earth fixed cell operation method through beam steering using a phased array antenna of an LEO satellite is described in detail with reference to FIGS. 3A and 3B.

FIG. 3A is a diagram for describing a quasi-earth fixed cell operation method of an LEO satellite using a phased array antenna (or an advanced phased array antenna) in an NTN communication system according to an embodiment of the disclosure.

Referring to FIG. 3A, an LEO satellite 301 may include a phased array antenna mounted thereon. The phased array antenna may include a plurality of small antenna elements arranged at regular intervals. The antenna elements may generate radio waves of different frequencies, and the radio waves may interfere with each other to generate new waveforms. At this time, by adjusting the phase difference between the radio waves of the antenna elements, new waveforms may be focused in a specific direction. For example, in a case where it is assumed that two antenna elements are present and the two antenna elements are arranged on a vertical line, when the first antenna element is directed to the west and the second antenna element is directed to the east, the phase difference occurs between two radio waves and causes the direction of the new radio waves to be focused toward the north. As such, the phased array antenna may transmit or receive more powerful radio waves in a specific direction by focusing radio waves in a desired direction by using a plurality of small antenna elements. Because communication coverage expands as the radio waves become stronger, the use of the phased array antenna may enable seamless communication over longer distances and further improve a data transmission rate. In addition, because the phased array antenna electronically controls the phases of the antenna elements, the phase difference between the radio waves of the antenna elements may be controlled without physical movement of antennas.

The NTN communication system may accurately focus beams on a specific area on the ground by applying the phased array antennas to the LEO satellites. This may expand the communication coverage, may improve the data transmission rate, and may reduce the power consumption. In addition, because the phased array antenna may electronically control the phases of the antenna elements, it is possible to continuously track the position of the Earth and maintain communication without physical movement of the antenna of the LEO satellite, and it is possible to maintain beams at a certain area on the ground and form the quasi-earth fixed cell with the beam.

For example, in FIG. 3A, the LEO satellite 301 may electronically control the phases of the antenna elements of the phased array antenna so that the beam of the LEO satellite 301 may be focused in a specific direction without physical movement of the phased array antenna. Accordingly, the LEO satellite 301 may form the beam in a certain area on the ground and form the quasi-earth fixed cell 310 with the beam.

The key to the quasi-earth fixed cell operation method in the NTN communication system is the method and accuracy of forming the quasi-earth fixed cell in the same area of the Earth by steering the beam of the phased array antenna even while the LEO satellite is moving at high speed. The steering of the beam in the LEO satellite may be classified into physical steering by a motor and electromagnetic steering using phase difference. The physical beam steering method is intuitive, but has limitations in forming the quasi-earth fixed cell because it is difficult to change a beam direction quickly and it is impossible to change a beam angle quickly. Therefore, latest LEO satellites are designed to perform the function of electromagnetically steering the beam by carrying the phased array antenna, and a plurality of LEO satellites utilize the phased array antenna to electromagnetically steer the beam.

To continuously change the beam angle, the phase change for each antenna element has to be calculated and applied for each slight angle change. However, calculating and applying the phase change for each antenna element in real time has high computational complexity and burden on hardware in an environment where the beam direction has to be changed quickly. Therefore, to steer the beam without real-time calculation in the LEO satellite, a phase setting value for each corresponding antenna element is pre-calculated for each defined satellite beam steering angle and is used as data. The LEO satellite may discretely steer the beam to form the quasi-earth fixed cell by applying pre-calculated phase setting value data for each antenna element according to a spacing criteria between the defined beam steering angles. That is, the LEO satellite does not steer the beam in real time to accurately steer the beam to the center point of the area forming the quasi-earth fixed cell, maintains the beam until the quasi-earth fixed cell is maintained in the area, and changes the beam to a next steering angle.

For example, in FIG. 3A, a circle in the center represents the quasi-earth fixed cell 310 formed by the LEO satellite 301, and a large circle around the circle represents the beam formed by the LEO satellite 301. It is assumed that the LEO satellite 301 moves to the right during the time point T1→T2→T3. At the time point T1, the LEO satellite 301 changes the beam phase at a beam angle where the quasi-earth fixed cell 310 is present on the right side of the beam. Thereafter, the LEO satellite 301 moves to the position of the time point T2 and does not change the beam angle, i.e., the beam phase, while moving during the time point T1→T2. That is, the beam of the LEO satellite 301 also moves to the right in the same direction as the movement of the LEO satellite 301, and at the time point T2, the quasi-earth fixed cell 310 is present on the left side of the beam of the LEO satellite 301.

Thereafter, when the LEO satellite 301 passes the time point T2, the beam that is being formed at the current beam angle shows signal strength (or coverage) that is insufficient to provide communication service to the quasi-earth fixed cell 310. Therefore, at the time point T2, the LEO satellite 301 changes the beam based on the pre-calculated phase setting value data for each antenna element, which corresponds to the defined satellite beam steering angle. This is referred to as beam switching in FIG. 3A. At the time point T2, the LEO satellite 301 forms the quasi-earth fixed cell 310 by steering the beam angle to the left by the defined satellite beam steering angle to form the beam at a position similar to the beam at the time point T1. Thereafter, the LEO satellite 301 does not change the beam angle from the time points T2 to T3, and the quasi-earth fixed cell 310 is present again on the left side of the beam.

In the NTN communication system, the LEO satellite 301 may reduce high computational complexity and hardware burden by forming the quasi-earth fixed cell 310 in a certain area on the ground while discretely changing the beam angle as described above.

FIG. 3B is a diagram for describing an example of a beam codebook of an LEO orbit satellite using a phased array antenna in an NTN communication system according to an embodiment of the disclosure.

Referring to FIG. 3B, a graph 300 is an example of a beam codebook of an LEO satellite using a phased array antenna. In the beam codebook of the graph 300, beams of LEO satellites are not continuous and are quantized (beam angle quantization). As described above with reference to FIG. 3A, the LEO satellite using the phased array antenna forms the quasi-earth fixed cell 310 on the ground while discretely changing the beam angle, so as to reduce high computational complexity and hardware burden. As in the example of the beam codebook of the graph 300, the LEO satellite transmits a limited number of beams at specific quantized angles and forms the quasi-earth fixed cell on the ground.

In the graph 300, y-coord [m] and x-coord [m] respectively represent y-axis and x-axis direction positions in the terrestrial coordinate system in meters (m). That is, the x-axis and the y-axis represent the positions covered on the ground by each beam that is projected by the LEO satellite. In the graph 300, the LEO satellite provides signal-to-noise ratio (SNR) conditions suitable for various positions on the ground by forming the quasi-earth fixed cell in a certain area on the ground through the quantized beams of the beam codebook. In a case where the LEO satellites use the same antenna beam codebook, the beam transmitted from the LEO satellite provides a higher SNR [dB] as the LEO satellite gets closer to the center of the beam codebook coverage of the LEO satellite, and provides a lower SNR [dB] as the beam transmitted from the LEO satellite gets closer to the periphery of the beam code book coverage of the LEO satellite.

In the NTN communication system, a beam quantization error (i.e., a beam pointing error) may occur due to beam angle quantization of the LEO satellite. The beam quantization error of the LEO satellite have a characteristic effect on a received signal of a ground UE connected to the LEO orbit satellite.

In the terrestrial network communication system, when the UE is located at a fixed position within a cell, the UE receives a signal from a base station with a constant strength when assuming that environmental characteristics between the base station and the UE (e.g., moving objects between the base station and the UE, a reflective environment between the base station and the UE, the presence or absence of a line-of-sight (LOS) path between the base station and the UE, etc.) are ideal. However, in the NTN communication system, even when the UE is located at a fixed position within a cell, in a case where an NTN cell to which the UE is connected is a quasi-earth fixed cell, the strength of the received signal of the UE exhibits a characteristic of changing due to a beam quantization error caused by beam angle quantization of the LEO satellite.

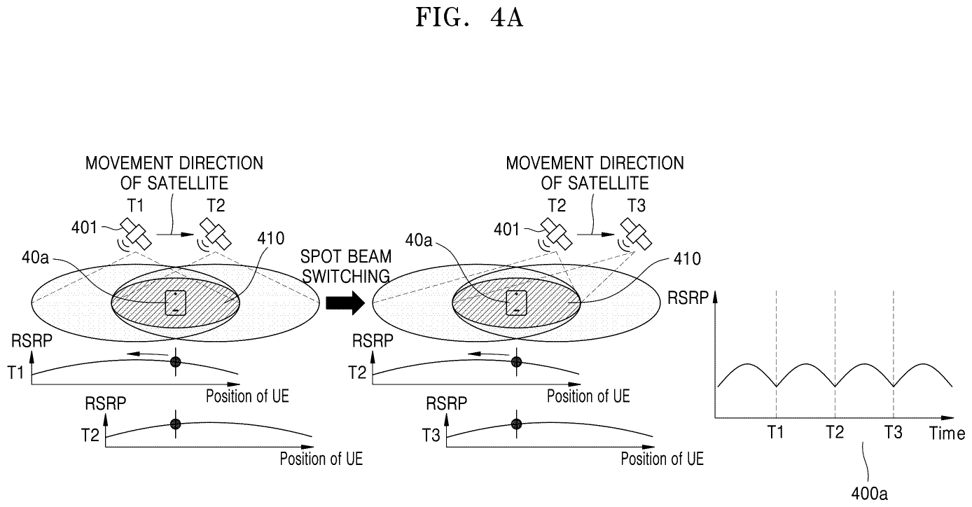

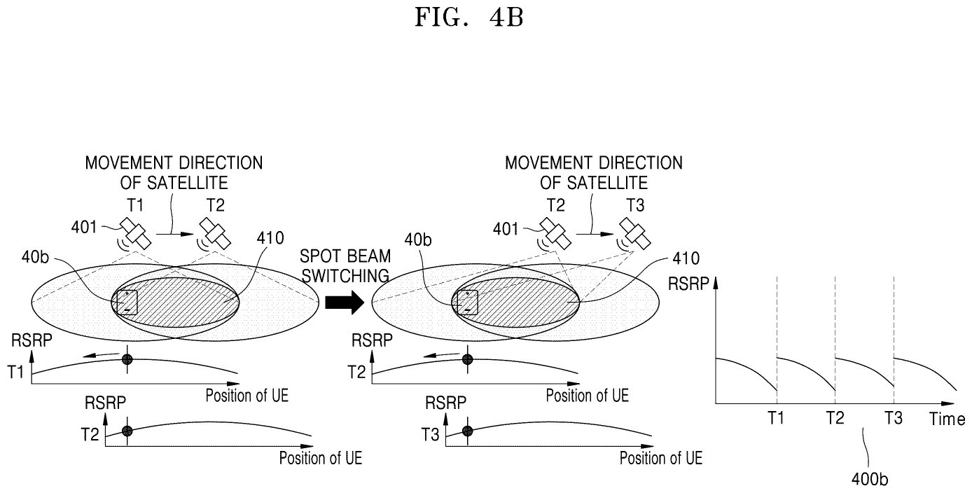

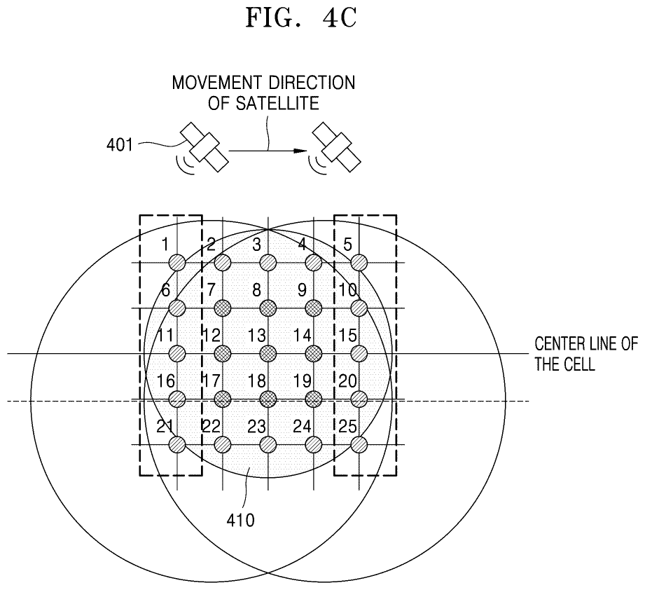

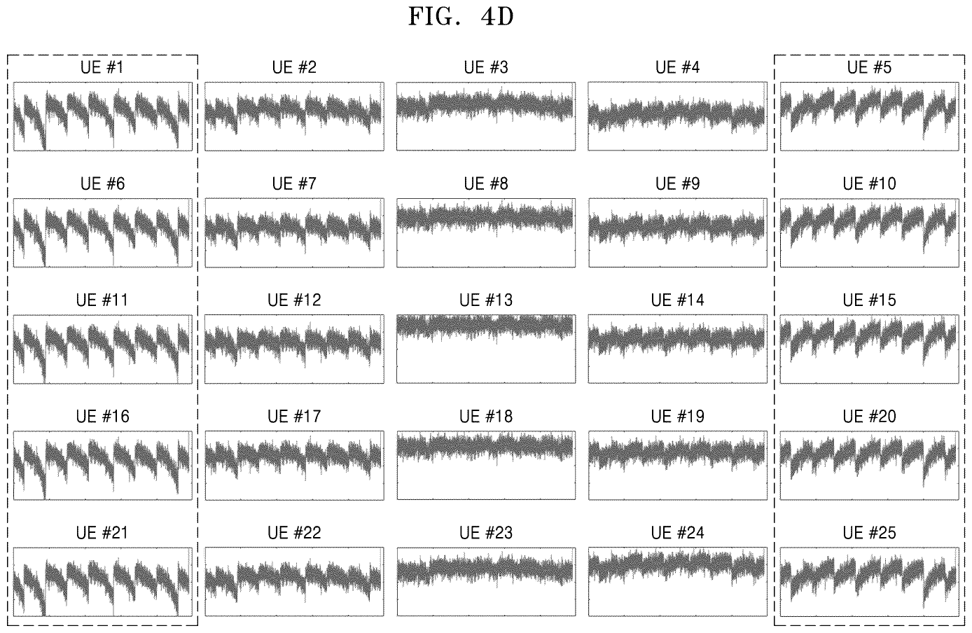

Hereinafter, the received signal characteristics according to the position of the UE within the cell caused by the beam quantization error of the LEO satellite are described in detail with reference to FIGS. 4A to 4D.

FIG. 4A is a diagram for describing a received signal change characteristic of a UE when the UE is located at a center of a quasi-earth fixed cell in an NTN communication system according to an embodiment of the disclosure.

Referring to FIG. 4A, an LEO satellite 401 using a phased array antenna forms a quasi-earth fixed cell 410 in a certain area on the ground according to the method described with reference to FIGS. 3A and 3B. A UE 40a is in a state capable of communicating with the quasi-earth fixed cell 410 and is located at the center of the quasi-earth fixed cell 410. It is assumed that the LEO satellite 401 moves to the right during the time point T1→T2→T3.

At the time point T1, when indicating the position with respect to the center of the beam, the UE 40a is located on the right side of the center of the beam. Thereafter, when the LEO satellite 401 moves during the time point T1→T2 while maintaining the beam angle, the UE 40a passes through the center of the beam and is located on the left side of the center of the beam at time point T2. Referring to the graph 300 of FIG. 3B, the signal strength within the ground beam coverage is highest at the center of the beam and decreases toward the periphery. During the time point T1→T2, the received signal strength of the UE 40a shows a characteristic of increasing from a value lower than the peak, arriving at the peak, and then decreasing to a value lower than the peak again.

The LEO satellite 401 performs beam switching at the time point T2 because the beam that is being formed at the current beam angle shows insufficient signal strength (or coverage) to provide a communication service to the quasi-earth fixed cell 410 after the time point T2. At the time point T2, the UE 40a is located on the right side of the center of the beam. Thereafter, when the LEO satellite 401 moves during the time point T2→T3 while maintaining the beam angle, the UE 40a passes through the center of the beam and is located on the left side of the center of the beam at time point T3. As in the time point T1→T2, the received signal strength of the UE 40a during the time point T2→T3 shows a characteristic of increasing from a value lower than the peak, arriving at the peak, and then decreasing to a value lower than the peak again.

A graph 400a of FIG. 4A shows a received signal change characteristic of the UE 40a located at the center of the quasi-earth fixed cell in the NTN communication system. As described above, unlike the terrestrial network communication system, in the NTN communication system, the received signal strength is not constant but variable even when the UE 40a is fixed at the center of the cell within the quasi-earth fixed cell. This is referred to as reference signal received power (RSRP) fluctuation based on a beam quantization error (or a beam pointing error).

FIG. 4B is a diagram for describing a received signal change characteristic of a UE when the UE is located at an edge of a quasi-earth fixed cell in an NTN communication system according to an embodiment of the disclosure.

Referring to FIG. 4B, an LEO satellite 401 using a phased array antenna forms a quasi-earth fixed cell 410 in a certain area on the ground according to the method described with reference to FIGS. 3A and 3B. A UE 40b is in a state capable of communicating with the quasi-earth fixed cell 410 and is located at the edge of the quasi-earth fixed cell 410. It is assumed that the LEO satellite 401 moves to the right during the time point T1→T2→T3.

At the time point T1, when indicating the position with respect to the center of the beam, the UE 40b is located at the center of the beam. Thereafter, when the LEO satellite 401 moves during the time point T1→T2 while maintaining the beam angle, the UE 40b gradually moves from the center of the beam to the left and is located on the left side of the center of the beam at time point T2. Referring to the graph 300 of FIG. 3B, the signal strength within the ground beam coverage is highest at the center of the beam and decreases toward the periphery. During the time point T1→T2, the received signal strength of the UE 40b shows a characteristic of gradually decreasing from the peak.

The LEO satellite 401 performs beam switching at the time point T2 because the beam that is being formed at the current beam angle shows insufficient signal strength (or coverage) to provide a communication service to the quasi-earth fixed cell 410 after the time point T2. At the time point T2, the UE 40b is located on the right side of the center of the beam. Thereafter, when the LEO satellite 401 moves during the time point T2→T3 while maintaining the beam angle, the UE 40b passes through the center of the beam and is located at the center of the beam at time point T3. As in the time point T1→T2, the received signal strength of the UE 40b during the time point T2→T3 shows a characteristic of gradually decreasing from the peak.

A graph 400b of FIG. 4B shows a received signal change characteristic of the UE 40b located at the edge of the quasi-earth fixed cell in the NTN communication system. As described above, unlike the terrestrial network communication system, in the NTN communication system, the received signal strength is not constant but variable even when the UE 40b is fixed at the edge of the cell within the quasi-earth fixed cell. This is referred to as RSRP fluctuation based on a beam quantization error (or a beam pointing error). As the beam spacing of the LEO satellite decreases, i.e., as the beam angles are quantized more densely, a beam quantization error (or a beam pointing error) decreases and RSRP fluctuation decreases. As the beam spacing of the LEO satellite increases, i.e., as the beam angles are quantized more sparsely, a beam quantization error (or a beam pointing error) increases and RSRP fluctuation increases.

As described with reference to FIGS. 4A and 4B, the signal change characteristic of the UE in the NTN communication system shows different change patterns depending on whether the position of the UE within the quasi-earth fixed cell is the center of the cell or the edge of the cell (see the graph 400a of FIG. 4A and the graph 400b of FIG. 4B). This is described in more detail through the related simulation results with reference to FIGS. 4C and 4D.

FIGS. 4C and 4D are diagrams for describing a received signal change characteristic simulation result according to a position of a UE within a quasi-earth fixed cell in an NTN communication system according to various embodiments of the disclosure.

FIG. 4C illustrates a simulation layout according to an embodiment of the disclosure.

Referring to FIG. 4C, an LEO satellite 401 forms a quasi-earth fixed cell 410 on the ground. It is assumed that the LEO satellite 401 moves to the right. The quasi-earth fixed cell 410 is divided into 25 areas, from area 1 to area 25, with respect to the movement direction of the satellite and the direction perpendicular to the movement direction of the satellite. It is assumed that 25 UEs are respectively located in areas 1 to 25 within the quasi-earth fixed cell 410 on the ground. The UE located in area 1 is referred to as a UE #1, the UE located in area 2 is referred to as a UE #2, . . . and the UE located in area 25 is referred to as a UE #25. The UE #1 to the UE #5, the UE #6, the UE #10, the UE #11, the UE #15, the UE #16, the UE #20, and the UE #21 to the UE #25 may be said to be located at the edge of the quasi-earth fixed cell 410, and the remaining UEs (the UE #7 to the UE #9, the UE #12 to the UE #14, and the UE #17 to the UE #19) may be said to be located at the center of the quasi-earth fixed cell 410.

FIG. 4D shows the results of observing the received signal change characteristics of the UE #1 to the #UE 25, based on the simulation layout of FIG. 4C according to an embodiment of the disclosure.

Referring to FIG. 4D, the change pattern is different depending on whether the UEs are located at the center in the direction perpendicular to the movement direction of the satellite or are located at the edge in the direction perpendicular to the movement direction of the satellite.

Specifically, the UEs (e.g., the UE #1, the UE #5, the UE #6, the UE #10, the UE #11, the UE #15, the UE #16, the UE #20, the UE #21, and the UE #25) located at the edge in the direction perpendicular to the movement direction of the satellite while being located at the edge of the quasi-earth fixed cell 410 exhibit the signal change characteristic shown in the graph 400b of FIG. 4B, and large RSRP fluctuation occurs. On the other hand, the UEs (e.g., the UE #3, the UE #4, the UE #23, and the UE #24, etc.) located at the edge of the quasi-earth fixed cell 410 but located at the center in the direction perpendicular to the movement direction of the satellite exhibit the signal change characteristic shown in the graph 400a of FIG. 4A, and relatively small RSRP fluctuation occurs.

Therefore, in the NTN communication system, the degree of RSRP fluctuation varies depending on whether the UE is located close to the edge in the direction perpendicular to the movement direction of the satellite within the quasi-earth fixed cell or is located close to the center in the direction perpendicular to the movement direction of the satellite within the quasi-earth fixed cell. Therefore, to prevent degradation of communication performance of the UE when the UE performs a handover/cell selection procedure in the NTN communication system, it is necessary to take into account the position of the UE within the quasi-earth fixed cell “related to the movement direction of the satellite.”

Hereinafter, the concept of cell area division newly defined in the disclosure is described in detail so as to take into account the position of the UE within the quasi-earth fixed cell “related to the movement direction of the satellite.”

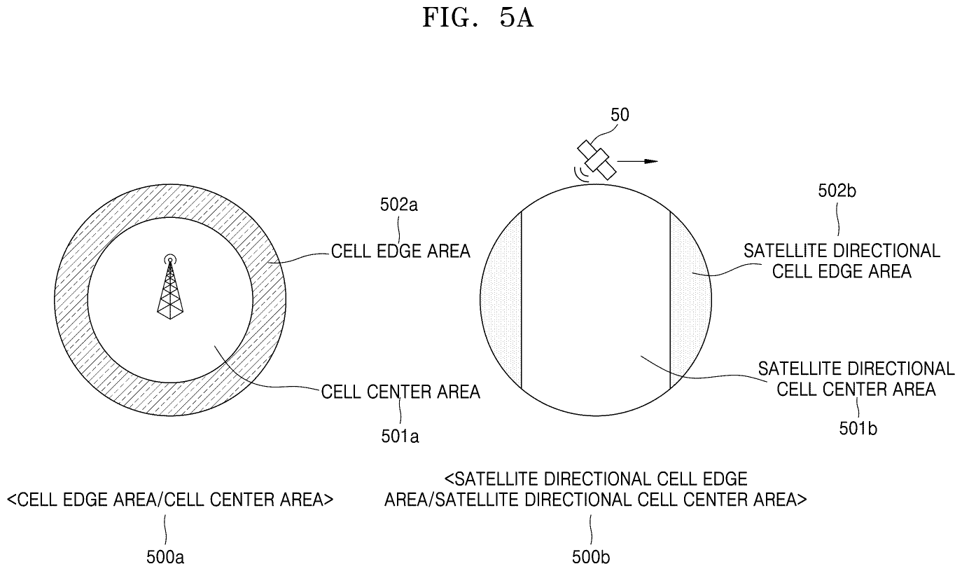

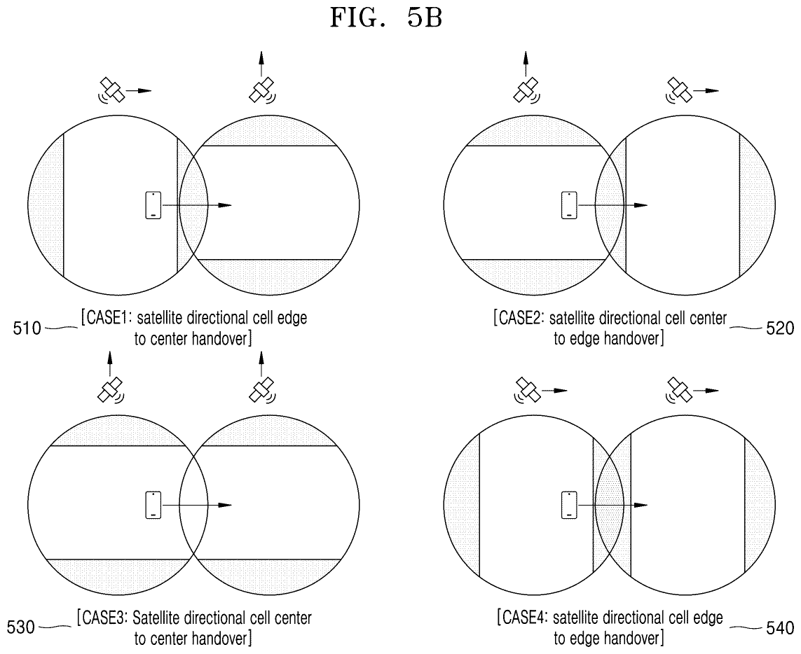

FIG. 5A is a diagram for describing the definition of a satellite directional cell center area and a satellite directional cell edge area within a quasi-earth fixed cell in an NTN communication system according to an embodiment of the disclosure.

Referring to FIG. 5A, in 500a, a cell center area 501a and a cell edge area 502a that are commonly used in a wireless communication system are described.

The cell center area 501a and the cell edge area 502a are distinguished based on a distance from a center of a cell where a base station is located. The area close to the center of the cell is defined as the “cell center area” 501a, and the area relatively far from the center of the cell is defined as the “cell edge area” 502a. In 500a, the cell center area 501a has a circular shape and the cell edge area 502a has a donut shape. In general, because the UE is closer to the base station as the UE is closer to the cell center area 501a, the signal strength increases, and thus, the communication performance is better. However, because the UE is farther away from the base station as the UE is closer to the cell edge area 502a, the communication performance is poorer.

In 500b of FIG. 5A, a satellite directional cell center area 501b and a satellite directional cell edge area 502b within a quasi-earth fixed cell in an NTN communication system newly defined in the disclosure are described.

The satellite directional cell center area 501b and the satellite directional cell edge area 502b are distinguished based on the shape of the quasi-earth fixed cell divided in the direction perpendicular to the movement direction of the satellite. When a satellite 50 moves, an area near a point where the beam of the satellite 50 enters a position capable of providing sufficient signal strength (or coverage) for communication services to the quasi-earth fixed cell and an area near a point where the beam of the satellite 50 changes to a position providing deficient/insufficient signal strength (or coverage) to provide communication services to the quasi-earth fixed cell are defined as the “satellite directional cell edge area” 502b. In the quasi-earth fixed cell, the remaining area excluding the “satellite directional cell edge area” 502b is defined as the “satellite directional cell center area” 501b. RSRP fluctuation caused by the beam switching of the satellite in the satellite directional cell center area 501b is small, and RSRP fluctuation caused by the beam switching of the satellite in the satellite directional cell edge area 502b is large. In terms of communication performance, the satellite directional cell edge area 502b has relatively unstable communication performance because the RSRP fluctuation of the satellite directional cell edge area 502b is larger than the RSRP fluctuation of the satellite directional cell center area 501b.

FIG. 5B is a diagram for describing examples of handover scenarios that take into account a position of a UE within a quasi-earth fixed cell related to a movement direction of a satellite in an NTN communication system according to an embodiment of the disclosure.

A UE located in a cell edge area 502a of a serving cell may perform a handover/cell selection procedure to one of neighbor cells. The UE located in the cell edge area 502a of the serving cell may be located in the satellite directional cell center area 501b or the satellite directional cell edge area 502b according to the cell area division “related to the movement direction of the satellite” newly defined in 500b of FIG. 5A. Accordingly, in the NTN communication system, the UE located in the edge area of the serving cell may experience four handover scenarios, as illustrated in FIG. 5B.

Referring to FIG. 5B, in CASE 1 510, the UE may be located in the satellite directional cell edge area within the serving cell and may be located in the satellite directional cell center area within the neighbor cell. In this case, when the UE performs the handover/cell selection procedure to the neighbor cell as the UE moves, the UE may perform handover from the satellite directional cell edge area to the satellite directional cell center area.

In CASE 2 520, the UE may be located in the satellite directional cell center area within the serving cell and may be located in the satellite directional cell edge area within the neighbor cell. In this case, when the UE performs the handover/cell selection procedure to the neighbor cell as the UE moves, the UE may perform handover from the satellite directional cell center area to the satellite directional cell edge area.

In CASE 3 530, the UE may be located in the satellite directional cell center area within the serving cell and may be located in the satellite directional cell center area within the neighbor cell. In this case, when the UE performs the handover/cell selection procedure to the neighbor cell as the UE moves, the UE may perform handover from the satellite directional cell center area to the satellite directional cell center area.

In CASE 4 540, the UE may be located in the satellite directional cell edge area within the serving cell and may be located in the satellite directional cell edge area within the neighbor cell. In this case, when the UE performs the handover/cell selection procedure to the neighbor cell as the UE moves, the UE may perform handover from the satellite directional cell edge area to the satellite directional cell edge area.

Hereinafter, examples of appropriate handover timing for each handover scenario (CASE 1 to CASE 4) taking into account the movement direction of the satellite in the NTN communication system are described in detail.

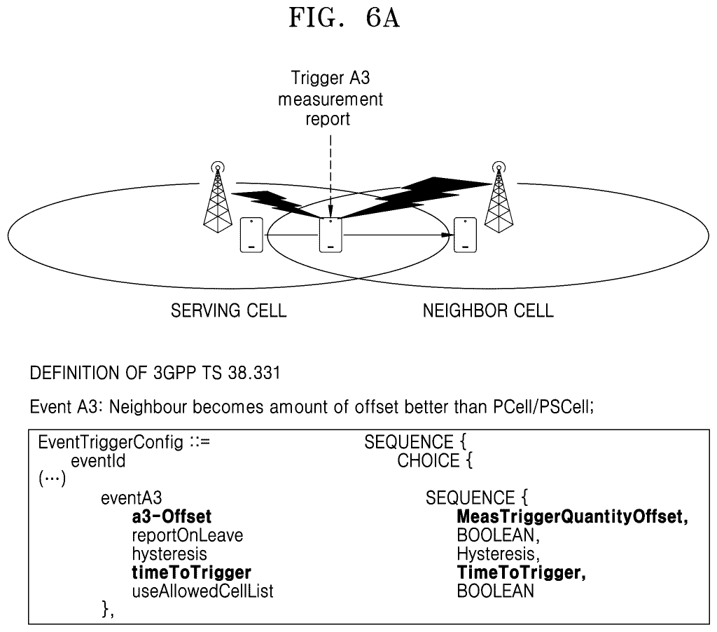

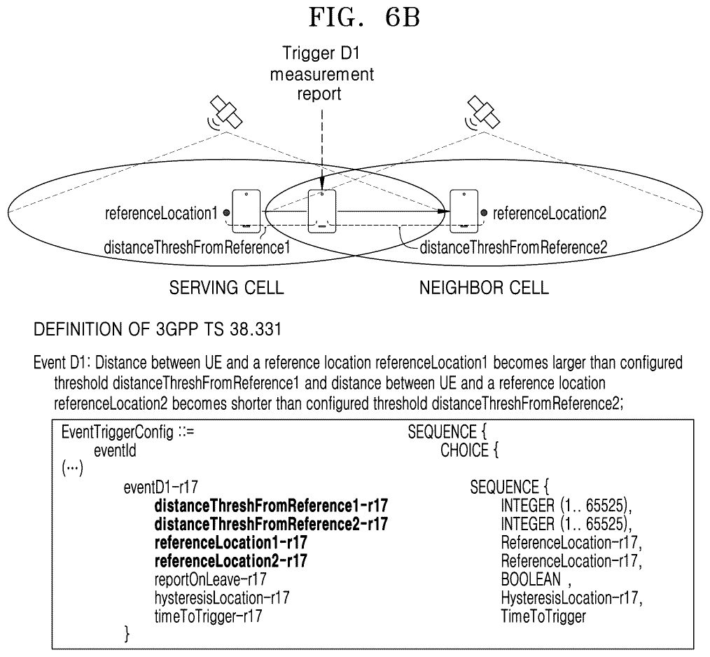

Prior to detailed description of examples of appropriate handover timing for each handover scenario (CASE 1 to CASE 4) taking into account the movement direction of the satellite, an RSRP-based handover mechanism and a distance-based handover mechanism in the existing 3GPP LTE or NR system are briefly described with reference to FIGS. 6A and 6B.

FIG. 6A is a diagram for described an RSRP-based handover mechanism in a wireless communication system according to an embodiment of the disclosure.

Referring to FIG. 6A, in the wireless communication system, when a UE moves, the UE performs handover to change a connection to a cell with the best performance according to the position of the UE. The UE periodically measures a signal of a serving cell, which is a cell being currently connected, and determines whether the signal strength of the serving cell is good enough for communication. The UE also periodically measures the signal strength of surrounding neighbor cells and determines whether connecting to the neighbor cells is likely to improve communication quality. When the signal strength of the serving cell being currently connected falls below a certain reference, or when the signal strength of the neighbor cell is determined to be stronger than the signal strength of the serving cell, the UE may perform handover to the neighbor cell so as to improve communication performance.

RSRP of a base station may vary irregularly due to large scale fading based on the distance between the base station and the UE and small-scale fading caused by various factors including reflection/absorption of surrounding objects. This is referred to as RSRP fluctuation. Due to the RSRP fluctuation of the base station, the signal strength ranking of cells may be temporarily reversed. When the UE hands over to a cell with better performance, based on the temporary signal strength measurement result, communication performance may actually deteriorate. Therefore, to prevent such a problem, the 3GPP LTE or NR system controls the handover of the UE by defining various parameters that have to be satisfied so as to perform the handover.

For example, the 3GPP LTE or NR system defines time-to-trigger (TTT) and offset parameters. The TTT parameter indicates the time for which the handover conditions have to remain satisfied. A small TTT value causes handover to occur quickly. A large TTT value may maintain a stable connection state, but increases the possibility of unnecessary handover. The offset parameter indicates the signal strength difference between base stations required for a handover to be triggered. The offset parameter enables handover suitable for a specific situation by modifying the TTT parameter. For example, when a vehicle is moving at high speed, cells have to be changed within a short period of time. Accordingly, fast handover may be induced by configuring a small offsetting value. In contrast, when the UE receives service at a fixed position, a stable connection state may be maintained by configuring a large offsetting value.

Referring to the example of FIG. 6A, 3GPP TS 38.331 defines Event A3 as one scenario of RSRP-based handover. Event A3 is an event that triggers handover when the UE compares the signal strength between the serving cell (PCell or PSCell) and the neighbor cell and the signal strength of the neighbor cell is better than the signal strength of the current cell by a certain offset. In an EventTriggerConfig information element (IE) included in MeasConfig in an RRC reconfiguration message, handover-related parameters (i.e., a3-Offset, reportOnLeave, hysteresis, timeToTrigger, useAllowedCellList) whose eventId corresponds to event A3 are defined. The moving UE periodically measures the RSRP of the serving cell and the RSRP of neighbor cell. The UE may trigger an Event A3-based measurement report for handover when the difference between the signal strength of the serving cell and the signal strength of the neighbor cell is greater than a configured a3-Offset value. At this time, the handover is actually performed only when the a3-Offset signal strength condition is maintained for a configured timeToTrigger value. For example, in a case where a3-Offset is configured to +3 dB and timeToTrigger is configured to 320 ms, the UE triggers the Event A3-based measurement report for handover when the neighbor cell maintains a signal that is 3 dB stronger than the serving cell for 320 ms.

FIG. 6B is a diagram for described a distance-based handover mechanism in an NTN communication system according to an embodiment of the disclosure.

Referring to FIG. 6B, in the NTN communication system, the difference in strength of the received signal of the UE according to the distance from the center of the cell is not large, compared to the terrestrial network communication system. Accordingly, the efficiency of the signal strength-based handover/cell selection mechanism is reduced. To solve the above-described problems, 3GPP release 17 introduced a distance-based handover mechanism between a cell center and a UE.

A moving UE calculates a distance D1 between the center of the serving cell and the UE and a distance D2 between the center of the neighbor cell and the UE, based on information about the center of the serving cell and the center of the neighbor cell received from the NTN and positional information of the UE measured from a global navigation satellite system (GNSS) mounted on the UE. The UE determines whether to perform handover, based on the calculated D1 and D2, and distance threshold information (distanceThresholdReference1 or distanceThresholdReference2) received from the NTN.

Referring to the example of FIG. 6B, 3GPP TS 38.331 defines Event D1 as one scenario of distance-based handover. Event D1 is an event that triggers handover based on the distance between the serving cell and the UE and between the neighbor cell and the UE, and may be particularly useful in the NTN. In the EventTriggerConfig IE included in MeasConfig in the RRC reconfiguration message, handover-related parameters (i.e., distanceThreshFromReference1-r17, distanceThreshFromReference2-r17, referenceLocation1-r17, referenceLocation2-r17, reportOnLeave-r17, hysteresisLocation-r17, or timeToTrigger-r17) whose eventId corresponds to event D1 are defined. A moving UE measures the distance between the UE and the center of the serving cell (referenceLocation1) and the distance between the UE and the center of the neighbor cell (referenceLocation2). The UE may trigger an Event D1-based measurement report for handover when the distance between the UE and referenceLocation1-17 becomes than a threshold larger preset distanceThreshFromReference1 and the distance between the UE and referenceLocation2 becomes shorter than a preset threshold distanceThreshFromReference2. For example, when distanceThreshFromReference1 is configured to 50 km and distanceThreshFrom Reference1 is configured to 30 km, the distance between the UE and the center of the serving cell (referenceLocation1) becomes greater than 50 km, and when the distance between the UE and the center of the neighbor cell (referenceLocation2) becomes less than 30 km, the UE triggers an EventD1-based measurement report for handover.

Hereinafter, an example of appropriate handover control for each handover scenario (CASE 1 to CASE 4) taking into account the movement direction of the satellite in the NTN communication system is described in detail, based on the existing handover mechanism described above with reference to FIGS. 6A and 6B.

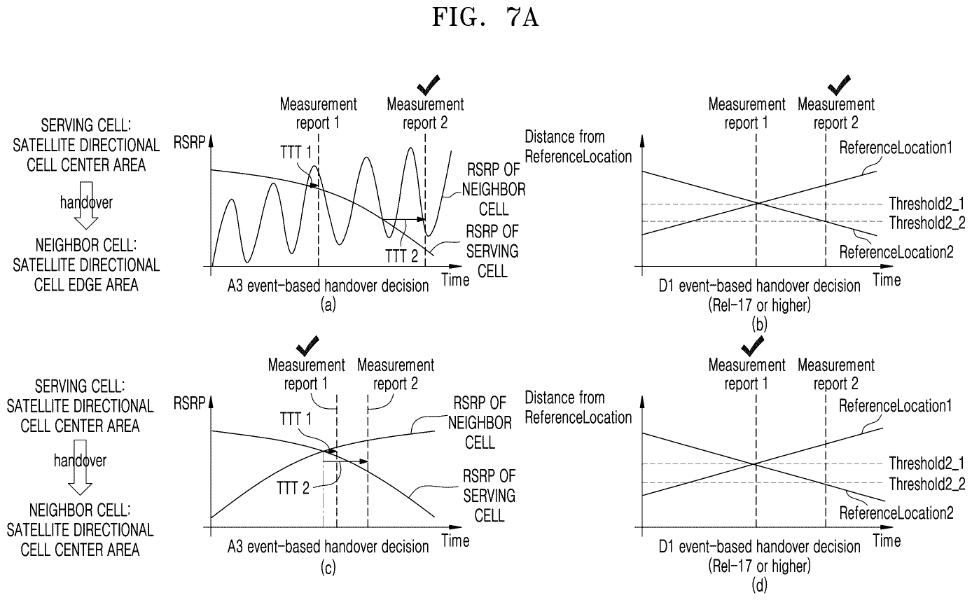

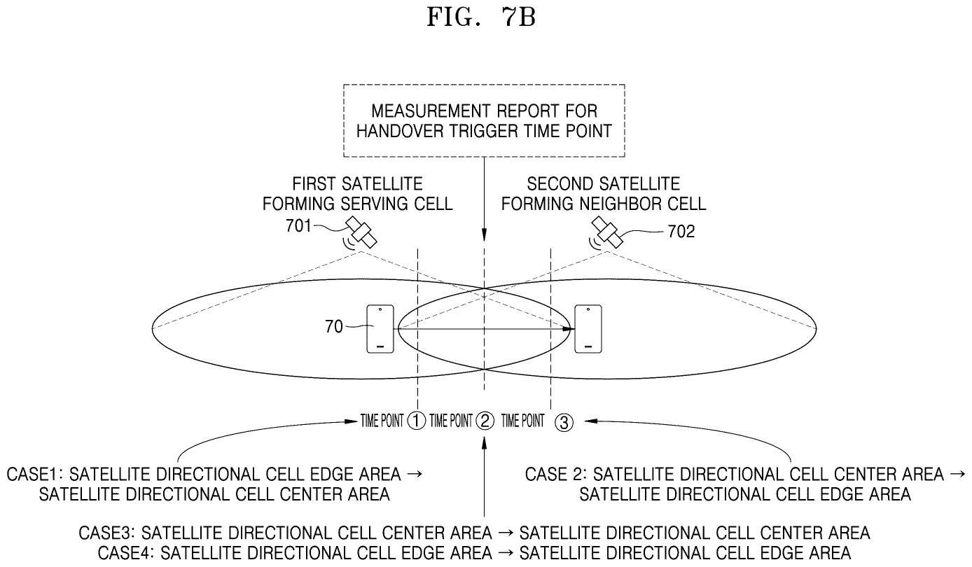

FIGS. 7A and 7B are diagrams for describing examples of appropriate handover control for each handover scenario (CASE 1 to CASE 4) that takes into account the movement direction of the satellite in the NTN communication system according to various embodiments of the disclosure.

In the terrestrial network, path loss according to the distance between the base station and the UE is the biggest factor that affects communication performance. Therefore, the base station and UE in the terrestrial network apply a handover mechanism (e.g., the handover mechanism described with reference to FIGS. 6A and 6B of the disclosure) designed based on the principle that UEs in the cell edge areas located at the same distance from the base station (ideally) exhibit similar performance.

However, in the NTN, unlike the terrestrial network, the center of the beam forming the cell moves, and accordingly, UEs in the cell edge area show performance changes according to the relationship with the movement direction of the satellite. (See the description provided with reference to FIGS. 3A, 3B, 4A, and 4B of the disclosure.) That is, even when the UEs are located in the cell edge area at the same distance from the quasi-earth fixed cell of the satellite, there is the difference in performance depending on whether the UEs are located in the satellite directional cell center area or the satellite directional cell edge area. As described above with reference to FIGS. 3A, 3B, 4A, and 4B of the disclosure, the satellite directional cell center area is stable and has less fluctuation in the received signal of the UE, but the satellite directional cell edge area is relatively unstable and has a very large fluctuation in the received signal of the UE. Therefore, when the base stations and the UEs in the NTN communication system apply the handover mechanism of the existing terrestrial network communication system without taking into account the movement direction of the satellites that form the serving cell and the neighbor cell, the UE may unintentionally hand over to a cell with poor communication performance. This leads to failure of UE mobility management and degradation of communication performance.

To solve the above-described problem, the NTN communication system requires a technology to select and apply optimal handover parameters for each handover scenario (e.g., CASE 1 to CASE 4 of FIG. 5B) by taking into account the position of the UE within the serving cell and the neighbor cell according to the movement direction of the satellite.

Referring to FIG. 7A, parts (a) and (b) of FIG. 7A illustrate examples of appropriate handover control in a case where the UE located in the satellite directional cell center area within the serving cell performs handover (UE in RRC connected state)/cell selection (UE in RRC idle state) to the satellite directional cell edge area within the neighbor cell (i.e., 520 of FIG. 5B, CASE 2). In this case, the satellite directional cell center area is stable and has less fluctuation in the received signal of the UE, but the satellite directional cell edge area is relatively unstable and has a very large fluctuation in the received signal of the UE. Therefore, the UE needs to recognize the fluctuation in the received signal in the satellite directional cell edge area within the neighbor cell and change a handover request time so that the handover request is made at a position closer to the center of the neighbor cell than an existing handover request time. The UE may appropriately control the handover timing by differentially applying handover parameters according to the satellite directional cell position within the serving cell and the neighbor cell.

For example, in the RSRP-based handover mechanism of part (a) of FIG. 7A, the TTT parameter value is configured to be longer, and in the distance-based handover mechanism of part (b) of FIG. 7A, distanceThreshFromReference1 is configured to be larger and distanceThreshFromReference1 is configured to be smaller. Accordingly, the handover request timing may be controlled with Measurement report 2, thereby preventing communication performance degradation in the CASE 2 handover scenario (satellite directional cell center area within the serving cell→satellite directional cell edge area within the neighbor cell).

In addition, for example, although not illustrated in FIG. 7A, in the case of the CASE 1 handover scenario (the satellite directional cell edge area within the serving cell→the satellite directional cell center area within the neighbor cell, 510 in FIG. 5B), the communication performance of the UE in the handover situation may be further improved by configuring the TTT parameter value to be shorter in the RSRP-based handover mechanism. In the distance-based handover mechanism, the communication performance of the UE in the handover situation may be further improved by configuring distanceThreshFromReference1 to be smaller and configuring distanceThreshFromReference1 to be larger.

Parts (c) and (d) of FIG. 7A illustrate examples of appropriate handover control in a case where the UE located in the satellite directional cell center area within the serving cell performs handover (UE in RRC connected state)/cell selection (UE in RRC idle state) to the satellite directional cell center area within the neighbor cell (i.e., 530 of FIG. 5B, CASE 3). In this case, for example, because the communication performance of the UE is stable in both the serving cell and the neighbor cell, the handover parameters used in the existing terrestrial network are configured without modification. In addition, for example, although not illustrated in FIG. 7A, in the case of the CASE 4 handover scenario (the satellite directional cell edge area within the serving cell→the satellite directional cell edge area within the neighbor cell, 540 in FIG. 5B), the handover parameters used in the existing terrestrial network are configured without modification because the communication performance of the UE is unstable in both the serving cell and the neighbor cell.

Hereinafter, embodiments proposed in the disclosure are briefly described with reference to FIG. 7B.

Referring to FIG. 7B, in the NTN communication system, a first satellite 701 may form a serving cell as a quasi-earth fixed cell by using a satellite operation antenna, and a second satellite 702 may form a neighbor cell as a quasi-earth fixed cell by using a satellite operation antenna. A UE 70 located in an edge area of the serving cell may perform a handover/cell selection procedure to a neighbor cell while moving. The UE 70 may control a handover timing by differentially applying handover parameters according to a satellite directional cell position within the serving cell and the neighbor cell.

In CASE 1 (e.g., 510 of FIG. 5B), the UE 70 may be located in the satellite directional cell edge area within the serving cell and located in the satellite directional cell center area within the neighbor cell. In this case, by applying the handover parameter corresponding to CASE 1, the measurement report for handover to the neighbor cell may be triggered at time point \textcircled{1}, which is earlier than the measurement report time point for the existing handover.

In CASE 2 (e.g., 520 of FIG. 5B), the UE 70 may be located in the satellite directional cell center area within the serving cell and located in the satellite directional cell edge area within the neighbor cell. In this case, by applying the handover parameter corresponding to CASE 2, the measurement report for handover to the neighbor cell may be triggered at time point \textcircled{3}, which is later than the measurement report time point for the existing handover.

In CASE 3 (e.g., 530 of FIG. 5B), the UE 70 may be located in the satellite directional cell center area within the serving cell and located in the satellite directional cell center area within the neighbor cell. In CASE 4 (e.g., 540 of FIG. 5B), the UE 70 may be located in the satellite directional cell edge area within the serving cell and located in the satellite directional cell edge area within the neighbor cell. In this case, by applying the handover parameter corresponding to CASE 3 or CASE 4, the measurement report for handover to the neighbor cell may be triggered at time point \textcircled{2}, which is the measurement report time point for the existing handover.

The purpose of the disclosure is to improve the communication performance of the UE and improve the QoS of the user by allowing the UE to select optimal handover parameters for each situation by taking into account the position of the UE within the serving cell and the neighbor cell according to the movement direction of the satellites when the UE performs the handover or cell selection procedure in the NTN communication system.

Specifically, the following embodiments of the disclosure are proposed.

1) A method, performed by a UE, of determining a position of the UE (whether the UE is located in a satellite directional cell center area or a satellite directional cell edge area) within a cell related to a movement direction of a satellite within a serving cell and a neighbor cell.

2) In an RSRP-based handover mechanism, a method, performed by a base station, of transmitting, to a UE, a measurement configuration for differential application according to a position of the UE within a cell related to a movement direction of a satellite.

3) In an RSRP-based handover mechanism, a method, performed by a UE, of differentially applying handover-related parameters associated with a position of the UE related to a movement direction of a satellite.

4) In a distance-based handover mechanism, a method, performed by a base station, of transmitting, to a UE, a measurement configuration for differential application according to a position of the UE within a cell related to a movement direction of a satellite.

5) In a distance-based handover mechanism, a method, performed by a UE, of differentially applying handover-related parameters associated with a position of the UE related to a movement direction of a satellite.

6) A method of differentially applying handover-related parameters associated with a position of a UE related to a movement direction of a satellite through the implementation of the UE.

7) An operation when satellites forming a serving cell and/or a neighbor cell changes.

Hereinafter, embodiments proposed in the disclosure are described in detail with reference to FIGS. 8, 9A, 9B, 10A, 10B, 11, 12A to 12C, 13A to 13C, 14, 15A, 15B, and 16 to 19.

FIG. 8 is a diagram for describing a method, performed by a UE 10 and a base station 20, of performing handover by taking into account a movement direction of a satellite in an NTN communication system according to an embodiment of the disclosure. The base station 20 may correspond to a quasi-earth fixed cell formed by an NTN satellite. The definitions of a satellite directional cell center area and a satellite directional cell edge area are the same as the description provided with reference to FIG. 5A, and redundant descriptions thereof are omitted herein.

Referring to FIG. 8, in operation 810, the base station 20 according to an embodiment of the disclosure may broadcast system information (SIB). The UE 10 may obtain the SIB from the base station 20. In the UE 10 and the base station 20 according to an embodiment of the disclosure, operation 810 may be optionally performed.

In an embodiment of the disclosure, the SIB may include a variety of information about the base station 20 and satellites connected to the base station 20. For example, the SIB may include at least one of satellite orbit information (e.g., satellite movement direction information), satellite position information, satellite velocity information, cell center position information, cell diameter information, information about neighbor cells, or information about neighbor satellites.

In an embodiment of the disclosure, the SIB may be SIB19. A 3GPP NR NTN system defined SIB19 as a broadcasting message including the above-described information in release 17. Table 1 is an example of an SIB19 structure, and Table 2 is an example of an NTN-Config IE structure in SIB19.

TABLE 1
[SIB19]
SIB19 contains satellite assistance information for NTN access.
SIB19 information element
-- ASN1 START
-- TAG-SIB19-START
SIB19-117 := SEQUENCE {

| | | |
|---|---|---|
| ntn-Config-r17 | NTN-Config-r17 | OPTIONAL, -- Need R |

...

| | | |
|---|---|---|
| ntn-NeighcellConfigList-r17 | NTN-NeighcellConfigList-r17 | OPTIONAL, -- Need R |
| lateNonCriticalExtension | OCTET STRING | OPTIONAL, |

```
  . . . ,
  [[
```

| | | |
|---|---|---|
| ntn-NeighCellConfigList-v1720 | NTN-NeighCellConfigList-r17 | OPTIONAL, -- Need R |

]]
}

| NTN-NeighcellConfigList-r17 ::= | SEQUENCE (SIZE (1 . .maxCellNTN-r17)) OF NTN-NeighCellConfigList-r17 | |
|---|---|---|
| NTN-NeighcellConfig-r17 ::= | SEQUENCE ( | |
| ntn-Config-17 | NTN-Config-17 | OPTIONAL, -- Need R |
| carrierFreq-r17 | ARFCN-ValueNR | OPTIONAL, -- Need R |
| physCellId-r17 | physCellId | OPTIONAL -- Need R |

}
-- TAG-SIB19-STOP
-- ASN1STOP

TABLE 2
[NTN-Config]
The IE NTN-Config provides parameters needed for the UE to access NR via NTN access.
NTN-Config information element
-- ASN1START
-- TAG-NTN-CONFIG-START

| NTN-CONFIG-r17 ::= | SEQUENCE { | |
|---|---|---|
| epochTime-r17 | EpochTime-117 | OPTIONAL, -- Need R |

. . .

| | | |
|---|---|---|
| ephemerisInfo-r17 | EphemerisInfo-r17 | OPTIONAL, -- Need R |
| ta-Report-r17 | ENUMERATED {enabled} | OPTIONAL, -- Need R |

. . .
}
-- TAG-NTN-CONFIG-STOP
-- ASN1STOP

In an embodiment of the disclosure, the SIB may include distance threshold information indicating a distance criteria that distinguishes between a satellite directional cell center area and a satellite directional cell edge area.

In operation 820, the base station 20 according to an embodiment of the disclosure may transmit an RRC reconfiguration message to the UE 10. The UE 10 may receive the RRC reconfiguration message from the base station 20. In the UE 10 and the base station 20 according to an embodiment of the disclosure, operation 820 may be optionally performed.

In an embodiment of the disclosure, the RRC reconfiguration message may include measurement configuration including handover-related parameters associated with the position of the UE related to the movement direction of the satellite.

In operation 830, the UE 10 according to an embodiment of the disclosure may determine whether the position of the UE related to the movement direction of the satellite within the serving cell is the satellite directional cell center area or the satellite directional cell edge area. In addition, the UE 10 may determine whether the position of the UE related to the movement direction of the satellite within the neighbor cell is the satellite directional cell center area or the satellite directional cell edge area. For example, the UE 10 may determine the positional relationship of the UE related to the movement direction of the satellite within the serving cell and the neighbor cell, like CASE 1 510, CASE 2 520, CASE 3 530, and CASE 4 540 of FIG. 5B.

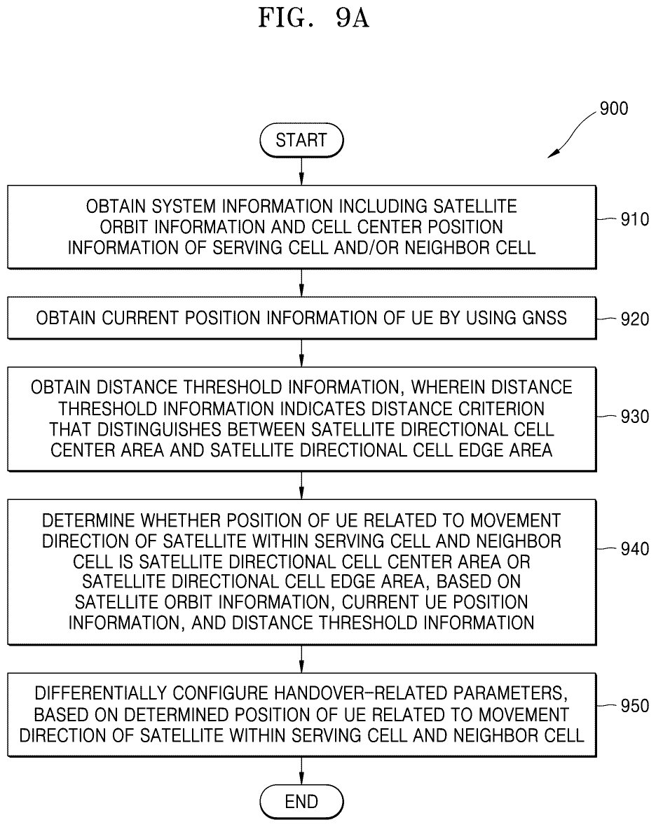

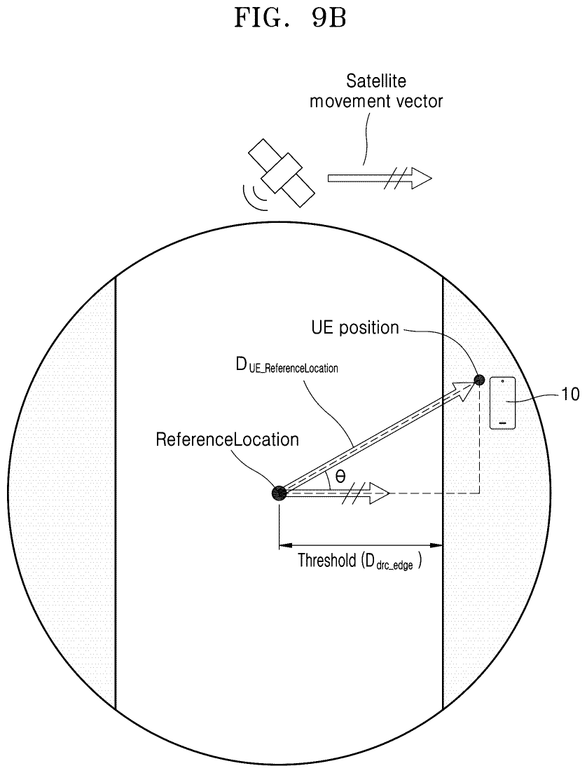

In an embodiment of the disclosure, the UE 10 may determine, based on the distance threshold information included in the SIB obtained in operation 810, whether the position of the UE related to the movement direction of the satellite is the satellite directional cell center area or the satellite directional cell edge area within the serving cell and the neighbor cell. This is described in detail with reference to FIGS. 9A and 9B.

An NR NTN-applied UE (i.e., a UE to which NR standards of NR Rel-17 or higher are applied) may obtain the satellite orbit information and the distance threshold information through the broadcasting message for NTN (e.g., SIB19) because the UE may use the broadcasting messages for NTN (e.g., SIB19). Accordingly, the NR NTN-applied UE (i.e., the UE to which NR standards of NR Rel-17 or higher are applied) may calculate the position of the UE within the cell related to the movement direction of the satellite within the serving cell and the neighbor cell, based on the broadcasting message for the NTN (e.g., SIB19) and may differentially apply the handover-related parameters by using the position of the UE. However, the disclosure is not limited thereto, and even an NR NTN-unapplied UE may perform the relevant operations of the disclosure when the UE may obtain the broadcasting message for NTN by other methods, including additional standard changes, etc.

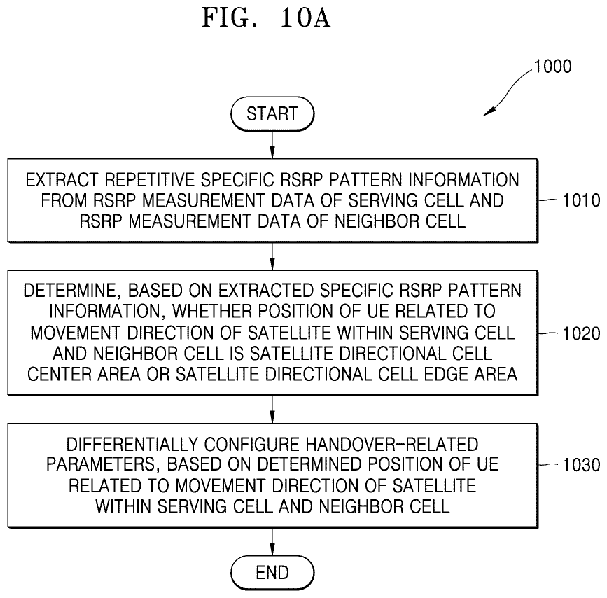

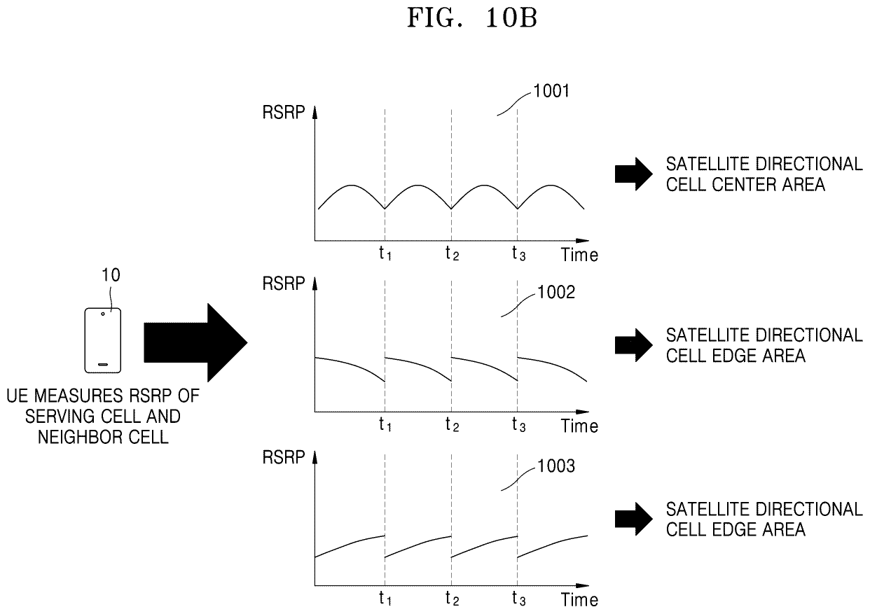

In an embodiment of the disclosure, the UE 10 may determine, based on RSRP pattern information of the serving cell and the neighbor cell, whether the position of the UE related to the movement direction of the satellite is the satellite directional cell center area or the satellite directional cell edge area within the serving cell and the neighbor cell. This is described in detail with reference to FIGS. 10A and 10B.

Because the NR NTN-unapplied UE (i.e., the UE to which LTE or NR standards of NR Rel-16 or lower are applied) is unable to use the broadcasting message for NTN (e.g., SIB19), the UE may calculate the position of the UE within the cell related to the movement direction of the satellite within the serving cell and the neighbor cell, based on the signal strength pattern, and differentially apply the handover-related parameters by using the position of the UE. In addition, it is obvious that the NR NTN-applied UE may perform the relevant operations of the disclosure based on the signal strength pattern.

In operation 840, the UE 10 according to an embodiment of the disclosure may differentially configure handover-related parameters associated with the position of the UE related to the movement direction of the satellite within the serving cell and the neighbor cell, which is determined in operation 830. For example, the UE 10 may configure the corresponding handover-related parameters associated with the determined positional relationship of the UE related to the movement direction of the satellite within the serving cell and neighbor cell (e.g., one of CASE 1 510, CASE 2 520, CASE 3 530, and CASE 4 540 in FIG. 5B).

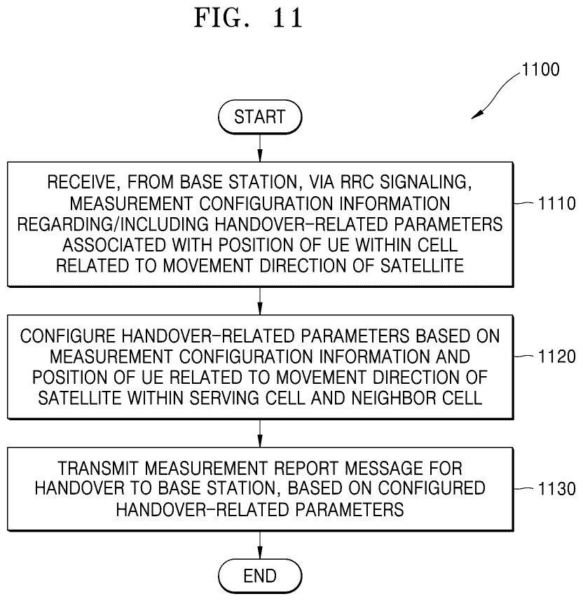

In an embodiment of the disclosure, the UE 10 may differentially configure the handover-related parameters associated with the position of the UE related to the movement direction of the satellite within the serving cell and the neighbor cell, which is determined in operation 830, based on the measurement configuration including the handover-related parameters associated with the position of the UE related to the movement direction of the satellite, which is included in the RRC reconfiguration message received in operation 820. This is described in detail with reference to FIGS. 11, 12A to 12C, and 13A to 13C.

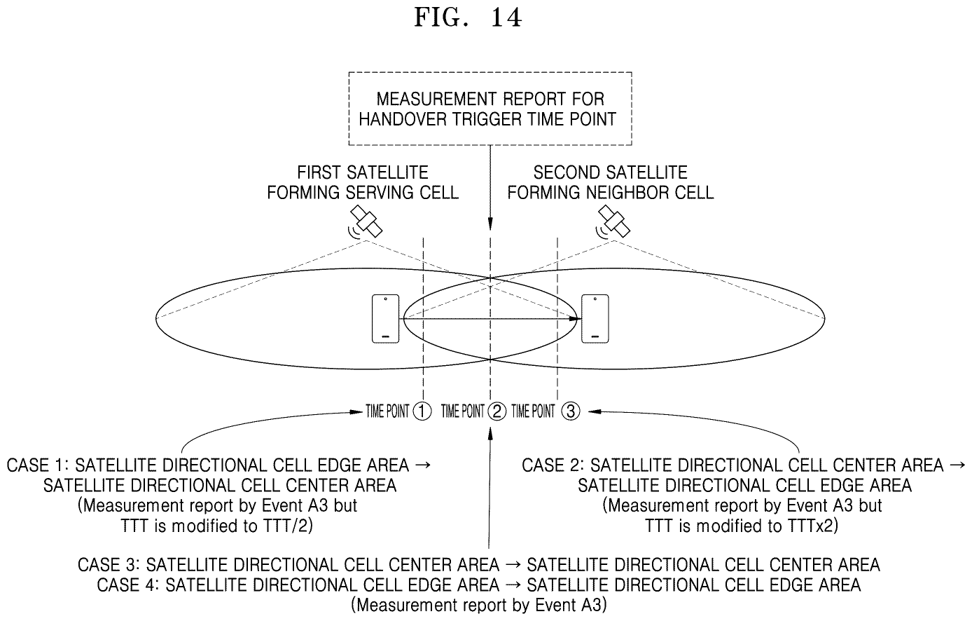

In an embodiment of the disclosure, the UE 10 may differentially configure the handover-related parameters associated with the position of the UE related to the movement direction of the satellite within the serving cell and the neighbor cell, which is determined in operation 830, according to the UE's own implementation. This is described in detail with reference to FIG. 14.

In operation 850, the UE 10 according to an embodiment of the disclosure may trigger a measurement report for handover when the handover-related parameters configured in operation 840 are satisfied. In operation 860, the UE 10 may transmit, to the base station 20, a measurement report message including a measurement result based on the handover-related parameters configured in operation 840. The base station 20 may receive the measurement report message from the UE 10, may transmit a handover request message to a target neighbor cell, and may transmit a handover command to the UE 10.

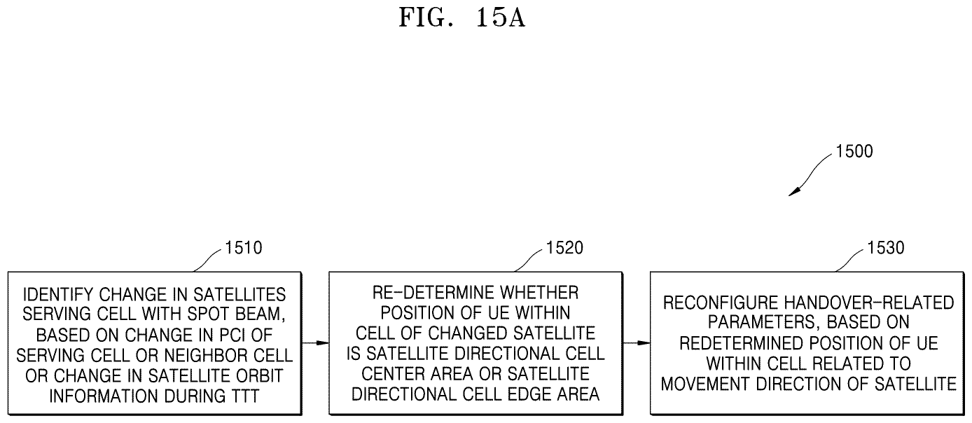

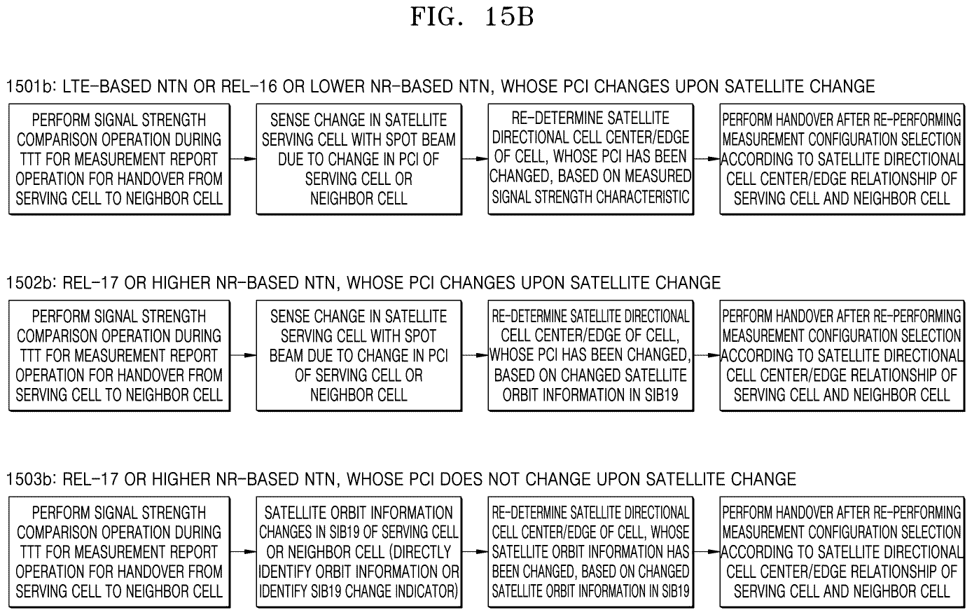

In an embodiment of the disclosure, the UE 10 according to an embodiment of the disclosure may re-perform operations 830 to 860 when the UE 10 identifies that the satellite forming the serving cell and/or the neighbor cell has changed. This is described in detail with reference to FIG. 15.

According to an embodiment of the disclosure, the communication performance of the UE and the QoS of the user may be improved by allowing the UE to select optimal handover parameters for each situation by taking into account the position of the UE within the serving cell and the neighbor cell according to the movement direction of the satellites when the UE performs the handover or cell selection procedure in the NTN communication system.

However, effects to be achieved by the disclosure are not limited to those described above, and other effects that are not mentioned herein will be clearly understood from the following description by those of ordinary skill in the art.

Hereinafter, a method, performed by the UE and the base station, of differentially configuring the handover-related parameters associated with the position of the UE related to the movement direction of the satellite, based on the distance threshold information is described in detail with reference to FIGS. 9A and 9B.

FIG. 9A is a flowchart of a method 900, performed by a UE and a base station, of differentially configuring handover-related parameters associated with a position of the UE related to a movement direction of a satellite, based on distance threshold information, in an NTN communication system according to an embodiment of the disclosure. The method 900 of FIG. 9A is applicable to a UE capable of using an NR standard protocol of NR Release 17 or higher or a UE capable of obtaining NTN cell information and satellite orbit information in a non-standard manner.

The definitions of a satellite directional cell center area and a satellite directional cell edge area are the same as the description provided with reference to FIG. 5A, and redundant descriptions thereof are omitted herein.

Referring to FIG. 9A, in operation 910, the UE 10 according to an embodiment of the disclosure may obtain system information including satellite orbit information and cell center position information of the serving cell and/or the neighbor cell. In an embodiment of the disclosure, the system information may be the SIB of operation 810 of FIG. 8. In an embodiment of the disclosure, the system information may be SIB19.

In an embodiment of the disclosure, the UE 10 may obtain orbit information (ephemerisInfo) of the satellite forming the serving cell, including movement direction information of the satellite forming the serving cell, location information (refenceLocation) of the center of the serving cell, and diameter information of the serving cell by decoding system information (e.g., SIB19) obtained from the serving cell.

In an embodiment of the disclosure, the UE 10 may obtain orbit information (ephemerisInfo) of the satellite forming the neighbor cell, including movement direction information of the satellite forming the neighbor cell, position information (refenceLocation) of the center of the neighbor cell, and diameter information of the neighbor cell by decoding system information (e.g., SIB19) obtained from the serving cell. For example, NeighCellConfig included in ntn-NeighCellConfigList IE of SIB 19 broadcast by the serving cell includes satellite direction information of the neighbor cell and center position information of the neighbor cell.

In an embodiment of the disclosure, when the SIB19 of the serving cell does not include information about the neighbor cell and the UE 10 enters a position where the UE is unable to receive the SIB19 of the neighbor cell, the UE 10 may obtain orbit information (ephemerisInfo) of the satellite forming the neighbor cell, including movement direction information of the satellite forming the neighbor cell, position information (refenceLocation) of the center of the neighbor cell, and diameter information of the serving cell by decoding the system information (e.g., SIB19) obtained from the neighbor cell.

In an embodiment of the disclosure, the UE 10 may obtain satellite orbit information and cell center position information of the serving cell and/or the neighbor cell through an interface other than SIB (e.g., an interface with a telecommunications company's cloud server, an interface with a smartphone manufacturer's cloud server, etc.) or based on prestored information.

In operation 920, the UE 10 according to an embodiment of the disclosure may obtain current mobility information of the UE or current position information of the UE by using a GNSS.

In operation 930, the UE 10 according to an embodiment of the disclosure may obtain distance threshold information. The distance threshold information indicates a distance criterion that distinguishes between the satellite directional cell center area and the satellite directional cell edge area.

In an embodiment of the disclosure, the UE 10 may obtain distance threshold information in at least one of the following methods.

i) The UE 10 may obtain a broadcasting message (e.g., SIB19) including distance threshold information and obtain distance threshold information by decoding the broadcasting message. The SIB obtained in operation 910 may include the distance threshold information along with the satellite orbit information of the serving cell and/or the neighbor cells.

ii) During the manufacturing process of the UE, a distance threshold for a specific NTN may be prestored in the UE and released. The UE 10 may configure the distance threshold information as a predefined/stored value.

iii) The UE 10 may receive the distance threshold information through an interface between the UE and a mobile network operator (MNO) or satellite network operator (SNO) connected to the NTN (e.g., an interface with a telecommunications company cloud server).

iv) The UE 10 may receive the distance threshold information through an interface with a server operated by a manufacturer of the UE 10 (e.g., a smartphone manufacturer's cloud server).

v) The UE 10 may receive the distance threshold information from a network function (e.g., unified data management (UDM), network data analytic function (NWDAF)) of a core network operated by an MNO or an SNO.

For example, when the UE 10 is a UE that connects to an NTN by using an NR standard protocol of NR Release 17 or higher, the UE 10 may obtain the distance threshold information by using the methods i) to v). For example, when the UE 10 is a UE that uses an LTE or NR standard protocol of lower than NR Release 17, the UE 10 may obtain the distance threshold information by using the methods ii) to v). However, even when the UE 10 is a UE that uses an LTE or NR standard protocol of lower than NR Release 17, the UE 10 may obtain the distance threshold information by using the method i) as long as the UE 10 may obtain the broadcasting message including the distance threshold information due to an additional standard change, etc.

In operation 940, the UE 10 according to an embodiment of the disclosure may determine, based on the distance threshold information (e.g., obtained in operation 930), whether the position of the UE related to the movement direction of the satellite within the serving cell and the neighbor cell is the satellite directional cell center area or the satellite directional cell edge area.

In an embodiment of the disclosure, the UE 10 may determine whether the position of the UE related to the movement direction of the satellite within the serving cell and the neighbor cell is the satellite directional cell center area or the satellite directional cell edge area, based on the satellite orbit information of the serving cell (e.g., obtained in operation 910), the satellite orbit information of the neighbor cell (e.g., obtained in operation 910), the current UE position information (e.g., obtained in operation 920), and the distance threshold information (e.g., obtained in operation 930). This is described in more detail with reference to FIG. 9B.

For example, the UE may determine the positional relationship of the UE related to the movement direction of the satellite within the serving cell and the neighbor cell, as shown in Table 3 below.

TABLE 3

| | Serving cell | Neighbor cell |
|---|---|---|
| CASE 1 (e.g., | Satellite directional | Satellite directional |
| 510 of FIG. 5B) | cell edge area | cell center area |
| CASE 2 (e.g., | Satellite directional | Satellite directional |
| 520 of FIG. 5B) | cell center area | cell edge area |
| CASE 3 (e.g., | Satellite directional | Satellite directional |
| 530 of FIG. 5B) | cell center area | cell center area |
| CASE 4 (e.g., | Satellite directional | Satellite directional |
| 550 of FIG. 5B) | cell edge area | cell edge area |

In operation 950, the UE 10 according to an embodiment of the disclosure may differentially configure handover-related parameters, based on the position of the UE related to the movement direction of the satellite within the serving cell and the neighbor cell, which is determined in operation 940. For example, when the UE 10 determines the position of the UE related to the movement direction of the satellite within the serving cell and the neighbor cell as in CASE 1, the UE 10 may configure the handover-related parameters corresponding to CASE 1 and perform handover measurement report based on the handover-related parameters. Similarly, when the UE 10 determines the position of the UE related to the movement direction of the satellite within the serving cell and the neighbor cell as in CASE 2, CASE 3, or CASE 4, the UE 10 may differentially configure the handover-related parameters corresponding to each situation.

FIG. 9B is a diagram for describing a method, performed by a UE, of determining a position of the UE within a cell related to a movement direction of a satellite, based on distance threshold information, in an NTN communication system according to an embodiment of the disclosure. The definitions of a satellite directional cell center area and a satellite directional cell edge area are the same as the description provided with reference to FIG. 5A, and redundant descriptions thereof are omitted herein.

Referring to FIG. 9B, the UE 10 according to an embodiment of the disclosure may determine whether the position of the UE related to the movement direction of the satellite within the serving cell and the neighbor cell is the satellite directional cell center area or the satellite directional cell edge area, based on the satellite orbit information of the serving cell (e.g., obtained in operation 910), the satellite orbit information of the neighbor cell (e.g., obtained in operation 910), the current UE position information (e.g., obtained in operation 920), and the distance threshold information (e.g., obtained in operation 930).

In an embodiment of the disclosure, the UE 10 may calculate a satellite movement vector (hereinafter referred to as a first vector) of the satellite forming the serving cell, based on the satellite orbit information of the serving cell. The UE 10 may measure current position coordinates of the UE by using a GNSS (e.g., a global positioning system (GPS)). The UE 10 may calculate a vector (hereinafter referred to as a second vector) that has the center of the serving cell (ReferenceLocation) as a start point and current position coordinates of the UE as an end point. The UE 10 may calculate cos θ for a smaller angle θ among angles formed by the first vector and the second vector. The UE 10 may compare a result value D_{UE_ReferenceLocation} cos θ, which is obtained by multiplying the distance D_{UE_ReferenceLocation} between the current position coordinates of the UE and the center of the serving cell (ReferenceLocation) and cos θ, with the distance threshold information Threshold (D_{drc_edge}). Based on the comparison result, the UE 10 may determine whether the UE 10 is located in the satellite directional cell center area or the satellite directional cell edge area within the serving cell.

For example, in the case of D_{UE_ReferenceLocation} cos θ≤D_{drc_edge}, the UE 10 may determine the position of the UE related to the movement direction of the satellite within the serving cell as the “satellite directional cell center area.” In the case of D_{UE_ReferenceLocation} cos θ>D_{drc_edge}, the UE 10 may determine the position of the UE related to the movement direction of the satellite within the serving cell as the “satellite directional cell edge area.”

Similarly, for the neighbor cell, the UE 10 may compare a result value D_{UE_ReferenceLocation} cos θ, which is obtained by multiplying the distance D_{UE_ReferenceLocation} between the current position coordinates of the UE and the center of the neighbor cell (ReferenceLocation) and cos θ, with the distance threshold information Threshold (D_{drc_edge}). Based on the comparison result, the UE 10 may determine whether the UE 10 is located in the satellite directional cell center area or the satellite directional cell edge area within the neighbor cell.

According to an embodiment of the disclosure, in the NTN communication system, the UE may determine the position of the UE within the serving cell and the neighbor cell according to the movement direction of the satellites, based on the distance threshold information. Accordingly, the communication performance of the UE and the QoS of the user may be improved by applying an optimal handover parameter that takes into account the movement direction of the satellite during handover/cell selection.

However, effects to be achieved by the disclosure are not limited to those described above, and other effects that are not mentioned herein will be clearly understood from the following description by those of ordinary skill in the art.

FIG. 10A is a flowchart of a method 1000, performed by a UE and a base station, of differentially configuring handover-related parameters associated with a position of the UE related to a movement direction of a satellite, based on repetitive specific RSRP pattern information, in an NTN communication system according to an embodiment of the disclosure. 1000 of FIG. 10A is a method that is applicable even when the UE is unable to obtain satellite orbit information and NTN cell information, and is applicable not only to a UE that uses an NR standard protocol of NR Release 17 or higher, but also to a UE that uses an LTE or NR standard protocol of lower than NR Release 17.

The definitions of a satellite directional cell center area and a satellite directional cell edge area are the same as the description provided with reference to FIG. 5A, and redundant descriptions thereof are omitted herein.

Referring to FIG. 10A, in operation 1010, the UE 10 according to an embodiment of the disclosure may extract repetitive specific RSRP pattern information from RSRP measurement data of the serving cell. The UE 10 may extract repetitive specific RSRP pattern information from the RSRP measurement data of the neighbor cell.

In operation 1020, the UE 10 according to an embodiment of the disclosure may determine, based on the extracted specific RSRP pattern information, whether the position of the UE related to the movement direction of the satellite within the serving cell and the neighbor cell is the satellite directional cell center area or the satellite directional cell edge area. This is described in more detail with reference to FIG. 10B. For example, the UE may determine the positional relationship of the UE related to the movement direction of the satellite within the serving cell and the neighbor cell, as shown in Table 3 above.

In operation 1030, the UE 10 according to an embodiment of the disclosure may differentially configure handover-related parameters, based on the position of the UE related to the movement direction of the satellite within the serving cell and the neighbor cell, which is determined in operation 1020. For example, when the UE 10 determines the position of the UE related to the movement direction of the satellite within the serving cell and the neighbor cell as in CASE 1, the UE 10 may configure the handover-related parameters corresponding to CASE 1 and perform handover measurement report based on the handover-related parameters. Similarly, when the UE 10 determines the position of the UE related to the movement direction of the satellite within the serving cell and the neighbor cell as in CASE 2, CASE 3, or CASE 4, the UE 10 may differentially configure the handover-related parameters corresponding to each situation.

FIG. 10B is a diagram for describing a method, performed by a UE, of determining a position of the UE within a cell related to a movement direction of a satellite, based on repetitive specific RSRP pattern information, in an NTN communication system according to an embodiment of the disclosure. The definitions of a satellite directional cell center area and a satellite directional cell edge area are the same as the description provided with reference to FIG. 5A, and redundant descriptions thereof are omitted herein.

In the NTN communication system, the change pattern of the received signal strength of the UE differs depending on whether the position of the UE within the quasi-earth fixed cell is the satellite directional cell center area or the satellite directional cell edge area. The description provided with reference to FIGS. 4A to 4D is equally applied thereto, and redundant descriptions thereof are omitted herein.

Referring to FIG. 10B, for example, when specific RSRP pattern information extracted from RSRP measurement data of the serving cell or the neighbor cell shows a pattern similar to a pattern 1001, the UE 10 may determine that the position of the UE related to the movement direction of the satellite within the cell is the “satellite directional cell center area.”

For example, when specific RSRP pattern information extracted from RSRP measurement data of the serving cell or the neighbor cell shows a pattern similar to a pattern 1002 or a pattern 1003, the UE 10 may determine that the position of the UE related to the movement direction of the satellite within the cell is the “satellite directional cell edge area.”

According to an embodiment of the disclosure, in the NTN communication system, the UE may determine the position of the UE within the serving cell and the neighbor cell according to the movement direction of the satellites, based on specific RSRP pattern information. Accordingly, the communication performance of the UE and the QoS of the user may be improved by applying an optimal handover parameter that takes into account the movement direction of the satellite during handover/cell selection.

However, effects to be achieved by the disclosure are not limited to those described above, and other effects that are not mentioned herein will be clearly understood from the following description by those of ordinary skill in the art.

Hereinafter, a method of differentially applying the handover-related parameters, based on the position of the UE related to the movement direction of the satellite within the serving cell and the neighbor cell determined according to the description provided with reference to FIGS. 9A and 9B or FIGS. 10A and 10B is described.

FIG. 11 is a diagram for describing a method 1100, performed by a UE and a base station, of performing handover by differentially applying handover-related parameters associated with a position of the UE related to a movement direction of a satellite in an NTN communication system according to an embodiment of the disclosure.

Referring to FIG. 11, in operation 1110, the UE 10 according to an embodiment of the disclosure may receive, from the base station 20, via RRC signaling (e.g., an RRC reconfiguration message), measurement configuration information including handover-related parameters associated with the position of the UE related to the movement direction of the satellite.

In an embodiment of the disclosure, the measurement configuration information including the handover-related parameters associated with the position of the UE related to the movement direction of the satellite may include event trigger configuration information.

In an embodiment of the disclosure, the event trigger configuration information may include a plurality of event identifier (ID) information. Each of the plurality of event ID information may correspond to the position of the UE related to the movement direction of the satellite within the serving cell and the neighbor cell (e.g., CASE 1 to CASE 4 of Table 3).

In an embodiment of the disclosure, the measurement configuration information or the event trigger configuration information may include information indicating the UE to change and apply specific handover-related parameters based on the position of the UE within the cell related to the movement direction of the satellite.

In operation 1120, the UE 10 according to an embodiment of the disclosure may configure handover-related parameters based on the measurement configuration information received in operation 1110 and the position of the UE related to the movement direction of the satellite within the serving cell and the neighbor cell, which is determined in operation 940 of FIG. 9A or operation 1020 of FIG. 10A.

In an embodiment of the disclosure, the UE 10 may identify specific event ID information corresponding to the position of the UE (e.g., one of CASE 1 to CASE 4 of Table 3) related to the movement direction of the satellite within the serving cell and the neighbor cell, which is determined in operation 940 of FIG. 9A or operation 1020 of FIG. 10A. The UE 10 may configure the handover-related parameters associated with the identified specific event ID information.

In operation 1130, the UE 10 according to an embodiment of the disclosure may transmit a measurement report message for handover to the base station 20, based on the handover-related parameters configured in operation 1120.

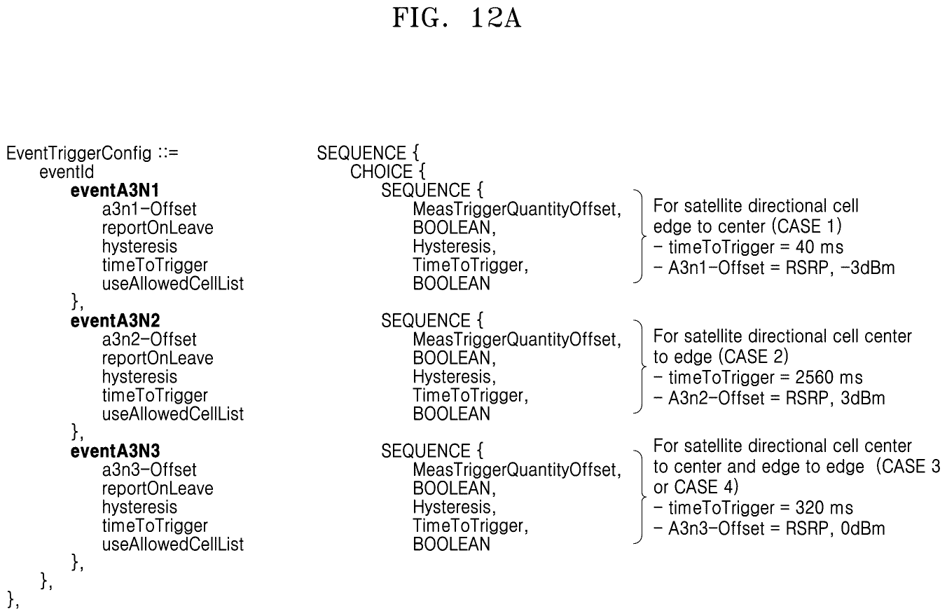

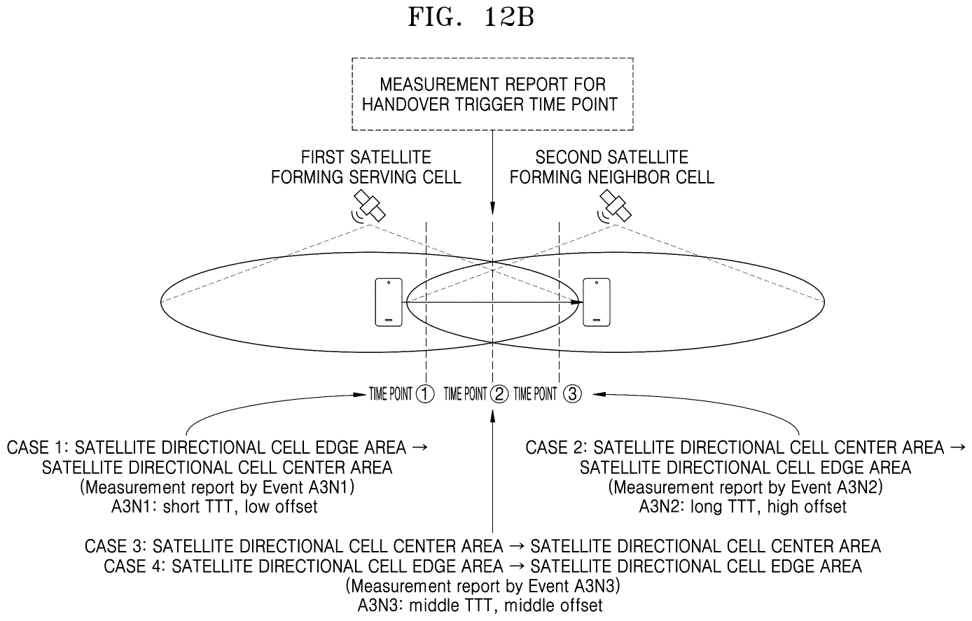

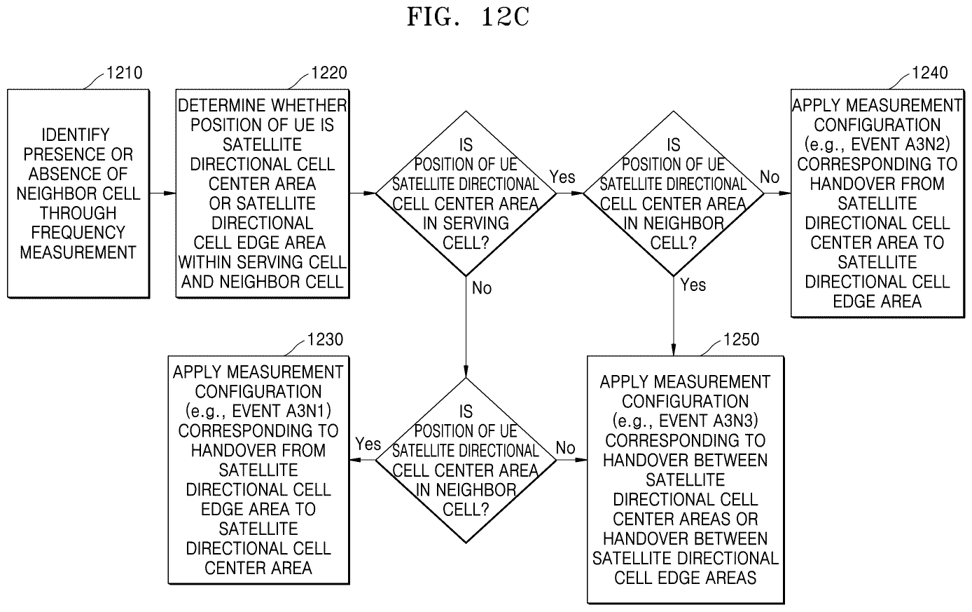

In an embodiment of the disclosure, the identified specific event ID information may be associated with an RSRP-based measurement report event triggering condition. The UE 10 may determine whether the setting values of the handover-related parameters associated with the identified specific event ID information are satisfied, based on the RSRP measurement result of the serving cell and the RSRP measurement result of the neighbor cell. When the UE 10 determines that the setting values are satisfied, the UE 10 may transmit a measurement report message for handover to the base station 20. This is described in detail with reference to FIGS. 12A to 12C.

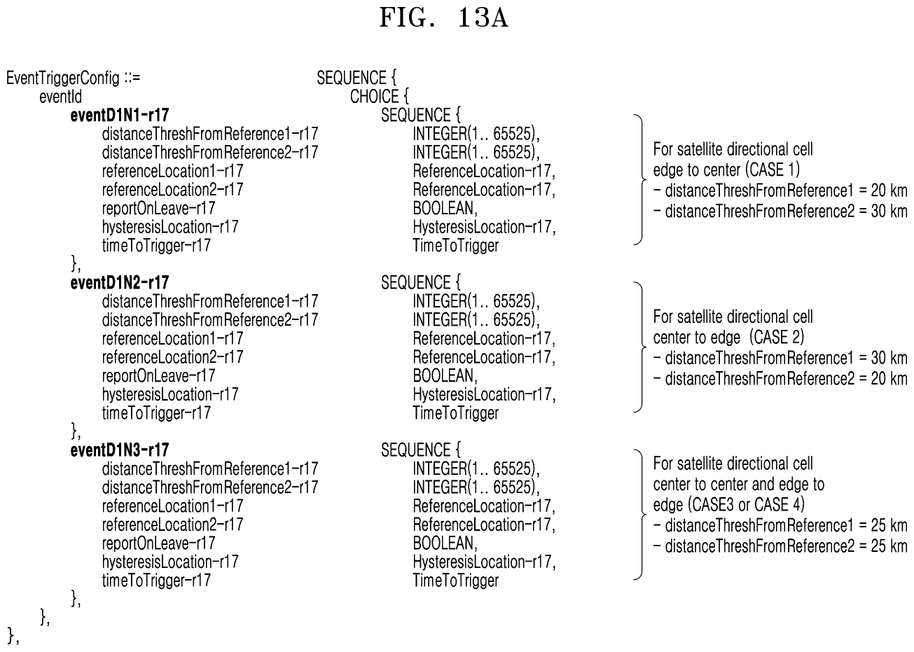

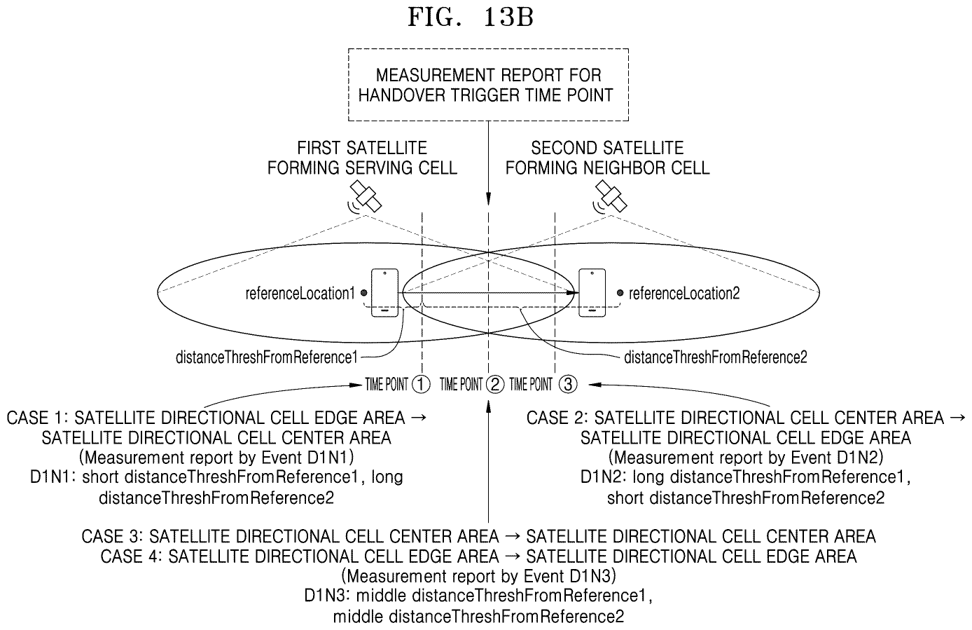

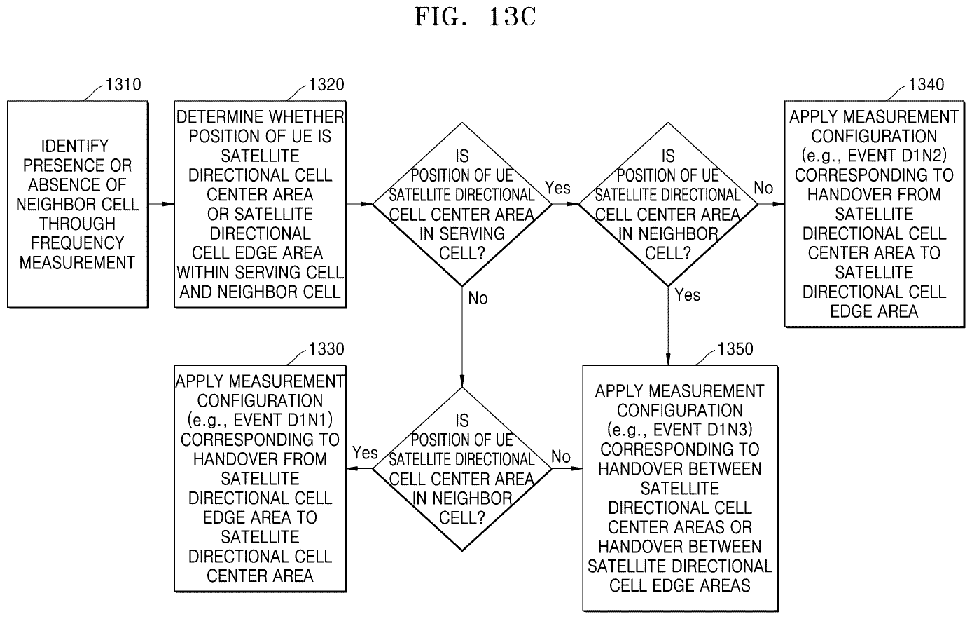

In an embodiment of the disclosure, the identified specific event ID information may be associated with a distance-based measurement report event triggering condition. The UE 10 may determine whether the setting values of the handover-related parameters associated with the identified specific event ID information are satisfied, based on the distance between the center of the serving cell and the UE and the distance between the center of the neighbor cell and the UE. When the UE 10 determines that the setting values are satisfied, the UE 10 may transmit a measurement report message for handover to the base station 20. This is described in detail with reference to FIGS. 13A to 13C.

According to an embodiment of the disclosure, the communication performance of the UE and the QoS of the user may be improved by allowing the UE to select optimal handover parameters for each situation by taking into account the position of the UE within the serving cell and the neighbor cell according to the movement direction of the satellites when the UE performs the handover or cell selection procedure in the NTN communication system.

However, effects to be achieved by the disclosure are not limited to those described above, and other effects that are not mentioned herein will be clearly understood from the following description by those of ordinary skill in the art.

Hereinafter, an example of specifically applying the embodiment of the disclosure described with reference to FIG. 11 to the RSRP-based handover mechanism is described with reference to FIGS. 12A to 12C.

FIG. 12A is a diagram for describing an example of a method, performed by a base station, of transmitting, to a UE, handover-related parameters associated with a position of the UE related to a movement direction of a satellite by using event ID information associated with RSRP-based handover in an NTN communication system according to an embodiment of the disclosure.

The definitions of a satellite directional cell center area and a satellite directional cell edge area are the same as the description provided with reference to FIG. 5A, and redundant descriptions thereof are omitted herein.

The description provided with reference to FIG. 6A is equally applied to the RSRP-based handover mechanism, and redundant descriptions thereof are omitted herein. The present embodiment of the disclosure is an example of a method by which a base station transmits measurement configuration information to a UE by subdividing the operation of requesting handover to the base station when the condition configured based on the RSRP relationship between the existing serving cell and the neighbor cell, which has been described with reference to FIG. 6A, is satisfied, so that handover-related parameters may be differentially applied according to the position of the UE within the cell related to the movement direction of the satellite. The present embodiment of the disclosure is designed based on the 3GPP mobile communication standard, but the disclosure is not limited thereto.

Referring to FIG. 12A, the base station 20 may transmit handover-related parameters to the UE 10 according to the position of the UE within the cell related to the movement direction of the satellite within the serving cell and the neighbor cell by using an EventTriggerConfig IE included in ReprotConfigNR of ReportConfigToAddModList of MeasureConfig of an RRC reconfiguration message.

In the example of FIG. 12A, the EventTriggerConfig IE may include eventA3N1 information, eventA3N2 information, and eventA3N3 information, which are obtained by subdividing eventA3 information.

The eventA3N1 information may include handover-related parameters corresponding to a case where the UE 10 is located in the satellite directional cell edge area within the serving cell and the satellite directional cell center area within the neighbor cell (e.g., CASE 1 of Table 3 above). In this case, because the satellite directional cell edge area has a very large fluctuation in the received signal of the UE and is relatively unstable, but the satellite directional cell center area has a small fluctuation in the received signal of the UE and is stable, the UE needs to change the handover request time point so that the handover request is made at a position closer to the center of the serving cell than the existing handover request time point (a short TTT value and a small offsetting value) (in this regard, refer to the description of FIGS. 7A and 7B. Redundant descriptions thereof are omitted herein). For example, the eventA3N1 information may include timeToTrigger=40 ms and A3n1-Offset=RSRP, −3 dBm.

The eventA3N2 information may include handover-related parameters corresponding to a case where the UE 10 is located in the satellite directional cell center area within the serving cell and the satellite directional cell edge area within the neighbor cell (e.g., CASE 2 of Table 3 above). In this case, because the satellite directional cell center area has a small fluctuation in the received signal of the UE and is stable, but the satellite directional cell edge area has a very large fluctuation in the received signal of the UE and is relatively unstable, the UE needs to change the handover request time point so that the handover request is made at a position closer to the center of the neighbor cell than the existing handover request time point (a long TTT value and a large offset value) (in this regard, refer to the description of FIGS. 7A and 7B. Redundant descriptions thereof are omitted herein). For example, the eventA3N2 information may include timeToTrigger=2,560 ms and A3n2-Offset=RSRP, 3 dBm.

The eventA3N3 information may include handover-related parameters corresponding to a case where the UE 10 is located in the satellite directional cell center area within the serving cell and the satellite directional cell center area within the neighbor cell (e.g., CASE 3 of Table 3 above) or a case where the UE 10 is located in the satellite directional cell edge area within the serving cell and the satellite directional cell edge area within the neighbor cell (e.g., CASE 4 of Table 3 above). In this case, because there is little difference in communication performance of the UE in the serving cell and the neighbor cell, the handover parameters used in the existing terrestrial network are configured without modification (appropriate TTT value, appropriate offset value) (in this regard, refer to the description of FIGS. 7A and 7B. Redundant descriptions thereof are omitted herein). For example, the eventA3N3 information may have parameter values that are intermediate in size between the eventA3N1 information and the eventA3N2 information. For example, the eventA3N3 information may include timeToTrigger=320 ms and A3n3-Offset=RSRP, 0 dBm.

Although FIG. 12A is described based on eventA3, the disclosure is not limited thereto, and a similar method may be applied to other event IDs (e.g., A4, A5, B1, B2, etc.) that determine the handover time point based on RSRP.

FIG. 12B is a diagram for describing an example of an RSRP-based handover mechanism that utilizes event ID information associated with RSRP-based handover for each handover scenario that takes into account a movement direction of a satellite in an NTN communication system according to an embodiment of the disclosure.

Referring to FIG. 12B, for example, when it is determined that the UE 10 is located in the satellite directional cell edge area within the serving cell and the satellite directional cell center area within the neighbor cell (e.g., CASE 1 of Table 3 above), the corresponding eventA3N1 information may be identified, and a short TTT value and a small offset value associated with the eventA3N1 information may be configured. When the UE 10 satisfies the condition that a state where the RSRP of the neighbor cell is stronger than the RSRP of the serving cell by a configured smaller offset value is maintained during a configured short TTT value as a result of measuring the RSRP of the serving cell and the neighbor cell, the UE 10 may transmit a measurement report message for handover to the base station 20.

For example, when it is determined that the UE 10 is located in the satellite directional cell center area within the serving cell and the satellite directional cell edge area within the neighbor cell (e.g., CASE 2 of Table 3 above), the corresponding eventA3N2 information may be identified, and a long TTT value and a large offset value associated with the eventA3N2 information may be configured. When the UE 10 satisfies the condition that a state where the RSRP of the neighbor cell is stronger than the RSRP of the serving cell by a configured large offset value is maintained during a configured long TTT value as a result of measuring the RSRP of the serving cell and the neighbor cell, the UE 10 may transmit a measurement report message for handover to the base station 20.

For example, when it is determined that the UE 10 is located in the satellite directional cell center area within the serving cell and the satellite directional cell center area within the neighbor cell (e.g., CASE 3 of Table 3 above), or when it is determined that the UE 10 is located in the satellite directional cell edge area within the serving cell and the satellite directional cell edge area within the neighbor cell (e.g., CASE 4 of Table 3 above), the corresponding eventA3N3 information may be identified and the TTT value and the offset value associated with the eventA3N3 information may be configured. When the UE 10 satisfies the condition that a state where the RSRP of the neighbor cell is stronger than the RSRP of the serving cell by a configured offset value is maintained during a configured long TTT value as a result of measuring the RSRP of the serving cell and the neighbor cell, the UE 10 may transmit a measurement report message for handover to the base station 20.

FIG. 12C is a diagram for describing an example of a method, performed by a UE, of differentially configuring RSRP-based handover-related parameters associated with a position of the UE related to a movement direction of a satellite in an NTN communication system according to an embodiment of the disclosure. Descriptions redundant with those provided with reference to FIGS. 12A and 12B refer to FIGS. 12A and 12B and are omitted herein.

Referring to FIG. 12C, in operation 1210, the UE 10 may identify the presence or absence of a neighbor cell through frequency measurement.

In operation 1220, the UE 10 may determine whether the position of the UE is a satellite directional cell center area or a satellite directional cell edge area within a serving cell and a neighbor cell. Operation 1220 may be performed similarly to operation 940 of FIG. 9A or operation 1020 of FIG. 10A.

In operation 1230, when the position of the UE is not the satellite directional cell center area in the serving cell and the position of the UE is the satellite directional cell center area in the neighbor cell, the UE 10 may apply measurement configuration (e.g., Event A3N1) corresponding to handover from the satellite directional cell edge area to the satellite directional cell center area.

In operation 1240, when the position of the UE is the satellite directional cell center area in the serving cell and the position of the UE is not the satellite directional cell center area in the neighbor cell, the UE 10 may apply measurement configuration (e.g., Event A3N2) corresponding to handover from the satellite directional cell center area to the satellite directional cell edge area.

In operation 1250, when the position of the UE is not the satellite directional cell center area in the serving cell and the position of the UE is not the satellite directional cell center area in the neighbor cell, or when the position of the UE is the satellite directional cell center area in the serving cell and the position of the UE is the satellite directional cell center area in the neighbor cell, the UE 10 may apply measurement configuration (e.g., Event A3N3) corresponding to handover between the satellite directional cell center areas or between the satellite directional cell edge areas.

According to an embodiment of the disclosure, the communication performance of the UE and the QoS of the user may be improved by subdividing RSRP-based handover triggering eventID in the NTN communication systems according to the position of the UE related to the movement direction of the satellite within the serving cell and the neighbor cell and allowing the UE to select optimal handover parameters for each situation.

However, effects to be achieved by the disclosure are not limited to those described above, and other effects that are not mentioned herein will be clearly understood from the following description by those of ordinary skill in the art.

Hereinafter, an example of specifically applying the embodiment of the disclosure described with reference to FIG. 11 to the distance-based handover mechanism is described with reference to FIGS. 13A to 13C.

FIG. 13A is a diagram for describing an example of a method, performed by a base station, of transmitting, to a UE, handover-related parameters associated with a position of the UE related to a movement direction of a satellite by using event ID information associated with distance-based handover in an NTN communication system according to an embodiment of the disclosure.

The definitions of a satellite directional cell center area and a satellite directional cell edge area are the same as the description provided with reference to FIG. 5A, and redundant descriptions thereof are omitted herein.

The description provided with reference to FIG. 6B is equally applied to the distance-based handover mechanism, and redundant descriptions thereof are omitted herein. The present embodiment is an example of a method by which a base station transmits measurement configuration information to a UE by subdividing the operation of requesting handover to the base station when the condition configured based on the distance between the center of the existing serving cell and the UE and the distance between the center of the neighbor cell and the UE, which has been described in FIG. 6B, is satisfied, so that handover-related parameters may be differentially applied according to the position of the UE within the cell related to the movement direction of the satellite. The present embodiment of the disclosure is designed based on the 3GPP mobile communication standard, but the disclosure is not limited thereto.

Referring to FIG. 13A, the base station 20 may transmit handover-related parameters to the UE 10 according to the position of the UE within the cell related to the movement direction of the satellite within the serving cell and the neighbor cell by using an EventTriggerConfig IE included in ReprotConfigNR of ReportConfigToAddModList of MeasureConfig of an RRC reconfiguration message.

In the example of FIG. 13A, the EventTriggerConfig IE may include eventD1N1 information, eventD2N2 information, and eventD3N3 information, which are obtained by subdividing eventD1 information.

The eventD1N1 information may include handover-related parameters corresponding to a case where the UE 10 is located in the satellite directional cell edge area within the serving cell and the satellite directional cell center area within the neighbor cell (e.g., CASE 1 of Table 3 above). In this case, because the satellite directional cell edge area has a very large fluctuation in the received signal of the UE and is relatively unstable, but the satellite directional cell center area has a small fluctuation in the received signal of the UE and is stable, the UE needs to change the handover request time point so that the handover request is made at a position closer to the center of the serving cell than the existing handover request time point (a small distanceThreshFromReference1 value and a large distanceThreshFromReference2 value) (in this regard, refer to the description of FIGS. 7A and 7B. Redundant descriptions thereof are omitted herein). For example, the eventD1N1 information may include distanceThreshFromReference1=20 km and distanceThreshFromReference2=30 km.

The eventD1N2 information may include handover-related parameters corresponding to a case where the UE 10 is located in the satellite directional cell center area within the serving cell and the satellite directional cell edge area within the neighbor cell (e.g., CASE 2 of Table 3 above). In this case, because the satellite directional cell center area has a small fluctuation in the received signal of the UE and is stable, but the satellite directional cell edge area has a very large fluctuation in the received signal of the UE and is relatively unstable, the UE needs to change the handover request time point so that the handover request is made at a position closer to the center of the neighbor cell than the existing handover request time point (a large distanceThreshFromReference1 value and a small distanceThreshFromReference2 value) (in this regard, refer to the description of FIGS. 7A and 7B. Redundant descriptions thereof are omitted herein). For example, the eventD1N2 information may include distanceThreshFromReference1=30 km and distanceThreshFromReference2=20 km.

The eventD1N3 information may include handover-related parameters corresponding to a case where the UE 10 is located in the satellite directional cell center area within the serving cell and the satellite directional cell center area within the neighbor cell (e.g., CASE 3 of Table 3 above) or a case where the UE 10 is located in the satellite directional cell edge area within the serving cell and the satellite directional cell edge area within the neighbor cell (e.g., CASE 4 of Table 3 above). In this case, because there is little difference in communication performance of the UE in the serving cell and the neighbor cell, the handover parameters used in the existing terrestrial network are configured without modification (an appropriate distanceThreshFromReference1 value and an appropriate distanceThreshFromReference2 value) (in this regard, refer to the description of FIGS. 7A and 7B. Redundant descriptions thereof are omitted herein). For example, the eventD1N3 information may have parameter values that are intermediate in size between the eventD1N1 information and the eventD1N2 information. For example, the eventD1N3 information may include distanceThreshFromReference1=25 km and distanceThreshFromReference2=25 km.

Although FIG. 13A is described based on eventD1, the disclosure is not limited thereto, and a similar method may be applied to other event IDs that determine the handover time point based on the distance.

FIG. 13B is a diagram for describing an example of a distance-based handover mechanism that utilizes event ID information associated with distance-based handover for each handover scenario that takes into account a movement direction of a satellite in an NTN communication system according to an embodiment of the disclosure.

Referring to FIG. 13B, for example, when it is determined that the UE 10 is located in the satellite directional cell edge area within the serving cell and the satellite directional cell center area within the neighbor cell (e.g., CASE 1 of Table 3 above), the corresponding eventD1N1 information may be identified, and a small distanceThreshFromReference1 value and a large distanceThreshFromReference2 value associated with the eventD1N1 information may be configured. As a result of measuring the distance between the center of the serving cell (referenceLocation1) and the UE and the distance between the center of the neighbor cell (referenceLocation2) and the UE, when the UE 10 satisfies the condition that the distance between the center of the serving cell (referenceLocation1) and the UE is greater than a configured small distanceThreshFromReference1 value and the distance between the center of the neighbor cell (referenceLocation2) and the UE is less than a configured large distanceThreshFromReference2 value, the UE 10 may transmit a measurement report message for handover to the base station 20.

For example, when it is determined that the UE 10 is located in the satellite directional cell center area within the serving cell and the satellite directional cell edge area within the neighbor cell (e.g., CASE 2 of Table 3 above), the corresponding eventD1N2 information may be identified, and a large distanceThreshFromReference1 value and a small distanceThreshFromReference2 value associated with the eventD1N2 information may be configured. As a result of measuring the distance between the center of the serving cell (referenceLocation1) and the UE and the distance between the center of the neighbor cell (referenceLocation2) and the UE, when the UE 10 satisfies the condition that the distance between the center of the serving cell (referenceLocation1) and the UE is greater than a configured large distanceThreshFromReference1 value and the distance between the center of the neighbor cell (referenceLocation2) and the UE is less than a configured small distanceThreshFromReference2 value, the UE 10 may transmit a measurement report message for handover to the base station 20.

For example, when it is determined that the UE 10 is located in the satellite directional cell center area within the serving cell and the satellite directional cell center area within the neighbor cell (e.g., CASE 3 of Table 3 above), or when it is determined that the UE 10 is located in the satellite directional cell edge area within the serving cell and the satellite directional cell edge area within the neighbor cell (e.g., CASE 4 of Table 3 above), the corresponding eventD1N3 information may be identified and the distanceThreshFromReference1 value and the distanceThreshFromReference2 value associated with the eventD1N3 information may be configured. As a result of measuring the distance between the center of the serving cell (referenceLocation1) and the UE and the distance between the center of the neighbor cell (referenceLocation2) and the UE, when the UE 10 satisfies the condition that the distance between the center of the serving cell (referenceLocation1) and the UE is greater than a configured distanceThreshFromReference1 value and the distance between the center of the neighbor cell (referenceLocation2) and the UE is less than a configured distanceThreshFromReference2 value, the UE 10 may transmit a measurement report message for handover to the base station 20.

FIG. 13C is a diagram for describing an example of a method, performed by a UE, of differentially configuring distance-based handover-related parameters associated with a position of the UE related to a movement direction of a satellite in an NTN communication system according to an embodiment of the disclosure. Descriptions redundant with those provided with reference to FIGS. 12A and 12B refer to FIGS. 13A and 13B and are omitted herein.

Referring to FIG. 13C, in operation 1310, the UE 10 may identify the presence or absence of a neighbor cell through frequency measurement.

In operation 1320, the UE 10 may determine whether the position of the UE is a satellite directional cell center area or a satellite directional cell edge area within a serving cell and a neighbor cell. Operation 1320 may be performed similarly to operation 940 of FIG. 9A or operation 1020 of FIG. 10A.

In operation 1330, when the position of the UE is not the satellite directional cell center area in the serving cell and the position of the UE is the satellite directional cell center area in the neighbor cell, the UE 10 may apply measurement configuration (e.g., Event A3N1) corresponding to handover from the satellite directional cell edge area to the satellite directional cell center area.

In operation 1340, when the position of the UE is the satellite directional cell center area in the serving cell and the position of the UE is not the satellite directional cell center area in the neighbor cell, the UE 10 may apply measurement configuration (e.g., Event D1N2) corresponding to handover from the satellite directional cell center area to the satellite directional cell edge area.

In operation 1350, when the position of the UE is not the satellite directional cell center area in the serving cell and the position of the UE is not the satellite directional cell center area in the neighbor cell, or when the position of the UE is the satellite directional cell center area in the serving cell and the position of the UE is the satellite directional cell center area in the neighbor cell, the UE 10 may apply measurement configuration (e.g., Event D1N3) corresponding to handover between the satellite directional cell center areas or between the satellite directional cell edge areas.

According to an embodiment of the disclosure, the communication performance of the UE and the QoS of the user may be improved by subdividing distance-based handover triggering eventID in the NTN communication systems according to the position of the UE related to the movement direction of the satellite within the serving cell and the neighbor cell and allowing the UE to select optimal handover parameters for each situation.

However, effects to be achieved by the disclosure are not limited to those described above, and other effects that are not mentioned herein will be clearly understood from the following description by those of ordinary skill in the art.

FIG. 14 is a diagram for describing an example of a method, performed by a UE, of differentially configuring handover-related parameters associated with a position of the UE related to a movement direction of a satellite through the UE's own implementation in an NTN communication system according to an embodiment of the disclosure.

The definitions of a satellite directional cell center area and a satellite directional cell edge area are the same as the description provided with reference to FIG. 5A, and redundant descriptions thereof are omitted herein.

The present embodiment of the disclosure is an embodiment of the disclosure that differentially applies handover-related parameters only through the implementation of the UE without changing the LTE/NR standards. It is assumed that the RRC reconfiguration message structure operates only with the implementation of the UE without adding eventID.

Referring to FIG. 14, the UE 10 according to an embodiment of the disclosure may arbitrarily change and configure the setting values of specific handover-related parameters, based on the determined position of the UE related to the movement direction of the satellite within the serving cell and the neighbor cell.

For example, when it is determined that the UE 10 is located in the satellite directional cell edge area in the serving cell and the satellite directional cell center area in the neighbor cell, the TTT value among the parameters of eventA3 may be used as a value (e.g., TTT/2) less than an existing TTT value.

For example, when it is determined that the UE 10 is located in the satellite directional cell center area in the serving cell and the satellite directional cell edge area in the neighbor cell, the TTT value among the parameters of eventA3 may be used as a value (e.g., TTT*2) greater than an existing TTT value.

For example, when it is determined that the UE 10 is located in the satellite directional cell center area in the serving cell and the satellite directional cell center area in the neighbor cell, or when it is determined that the UE is located in the satellite directional cell edge area in the serving cell and the satellite directional cell edge area in the neighbor cell, the TTT value among the parameters of eventA3 may be used as the existing TTT value without modification.

Although FIG. 14 is described based on eventA3, the disclosure is not limited thereto, and a similar method may be applied to other event IDs that determine the handover time point.

According to an embodiment of the disclosure, the communication performance of the UE and the QoS of the user may be improved by allowing the UE to select optimal handover parameters for each situation according to the position of the UE within the cell related to the movement direction of the satellite through the UE's own implementation in the NTN communication system.

However, effects to be achieved by the disclosure are not limited to those described above, and other effects that are not mentioned herein will be clearly understood from the following description by those of ordinary skill in the art.

FIGS. 15A and 15B are diagrams for describing an example of a method 1500, performed by a UE, of performing handover by taking into account a movement direction of a satellite, when a satellite is changed, in an NTN communication system according to various embodiments of the disclosure.

The definitions of a satellite directional cell center area and a satellite directional cell edge area are the same as the description provided with reference to FIG. 5A, and redundant descriptions thereof are omitted herein.

In the NTN communication system, the UE monitors whether a condition given in measurement configuration is satisfied during a TTT included in the measurement configuration. When the condition is continuously satisfied during the TTT, the UE transmits a measurement report to a base station. The base station determines handover based on the measurement report received from the UE. In a terrestrial network, a base station configuration change does not occur or occur very rarely during the TTT. However, in the NTN communication system according to the disclosure, the TTT may increase from milliseconds (ms) to seconds, and thus, a satellite switching phenomenon may occur. That is, the satellite forming the serving cell and/or the neighbor cell changes during the TTT. Accordingly, the disclosure includes an operation in a scenario where an NTN cell forming satellite changes during a TTT that monitors the signal strength of the serving cell and the neighbor cell or the distance from the serving cell and the neighbor cell.

Referring to FIG. 15A, in operation 1510, the UE 10 according to an embodiment of the disclosure may identify that at least one of a first satellite forming a serving cell or a second satellite forming a neighbor cell during a TTT has changed, based on a change in a physical cell ID (PCI) or a change in satellite orbit information.

In an embodiment of the disclosure, the UE 10 may identify that the first satellite forming the serving cell has changed according to a change in the PCI of the serving cell. The UE 10 may identify that the second satellite forming the neighbor cell has changed according to a change in the PCI of the neighbor cell.

In an embodiment of the disclosure, the UE 10 may identify that the first satellite forming the serving cell has changed, based on an identifier indicating that satellite orbit information included in the SIB of the serving cell has changed. The UE 10 may identify that the second satellite forming the neighbor cell has changed, based on an identifier indicating that satellite orbit information included in the SIB of the neighbor cell has changed.

In an embodiment of the disclosure, the UE 10 may identify that the first satellite forming the serving cell has changed by directly identifying the satellite orbit information included in the SIB of the serving cell. The UE 10 may identify that the second satellite forming the neighbor cell has changed by directly identifying the satellite orbit information included in the SIB of the neighbor cell.

In operation 1520, the UE 10 according to an embodiment of the disclosure may re-determine whether the position of the UE related to the movement direction of the satellite within the cell of the changed satellite is a satellite directional cell center area or a satellite directional cell edge area. Operation 1520 may be performed similarly to operation 830 of FIG. 8, 940 of FIG. 9A, or operation 1020 of FIG. 10A. Descriptions redundant with those provided with reference to FIG. 8, 9A, or 10A are omitted, and reference is made to FIG. 8, 9A, or 10A.

In operation 1530, handover-related parameters may be reconfigured based on the position of the UE within the cell related to the movement direction of the satellite, which is re-determined in operation 1520. Operation 1530 may be performed similarly to operation 840 of FIG. 8, operation 950 of FIG. 9A, operation 1030 of FIG. 10A, or operation 1120 of FIG. 11. Descriptions redundant with those provided with reference to FIG. 8, 9A, 10A, or 11 are omitted, and reference is made to FIG. 8, 9A, 10A, or 11.

Referring to FIG. 15B, the embodiment of FIG. 15A may be applied according to an NTN application protocol. For example, element 1501b describes an example in which an LTE-based UE or a Rel-16 or lower NR-based UE, whose PCI changes upon satellite change, reconfigures handover parameters, based on PCI change. Element 1502b describes an example in which a Rel-17 or higher NR-based UE, whose PCI changes along with satellite change, reconfigures handover parameters, based on PCI change. Element 1503b describes an example in which a Rel-17 or higher NR-based UE that maintains the same PCI regardless of satellite change reconfigures handover parameters, based on satellite orbit information change in SIB19.

According to an embodiment of the disclosure, in the NTN communication system, even when there is a change in the satellite forming the serving cell and/or the neighbor cell, the communication performance of the UE and the QoS of the user may be improved by allowing the UE to select optimal handover parameters for each situation according to the position of the UE within the cell related to the movement direction of the satellite.

However, effects to be achieved by the disclosure are not limited to those described above, and other effects that are not mentioned herein will be clearly understood from the following description by those of ordinary skill in the art.

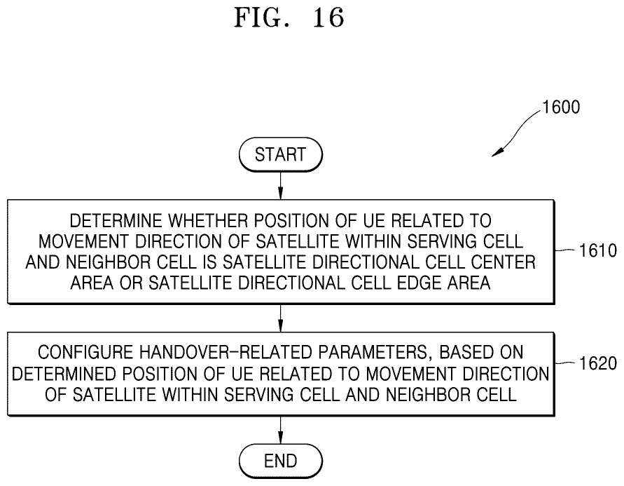

FIG. 16 is a diagram for describing a method, performed by the UE 10, of performing handover by taking into account a movement direction of a satellite in an NTN communication system according to an embodiment of the disclosure.

The definitions of a satellite directional cell center area and a satellite directional cell edge area are the same as the description provided with reference to FIG. 5A, and redundant descriptions thereof are omitted herein.

Referring to FIG. 16, in operation 1610, the UE 10 according to an embodiment of the disclosure may determine whether the position of the UE related to the movement direction of the satellite within the serving cell and the neighbor cell is a satellite directional cell center area or a satellite directional cell edge area. Operation 1610 may be performed similarly to operation 830 of FIG. 8, 940 of FIG. 9A, or operation 1020 of FIG. 10A. Descriptions redundant with those provided with reference to FIG. 8, 9A, or 10A are omitted, and reference is made to FIG. 8, 9A, or 10A.

In operation 1620, the UE 10 according to an embodiment of the disclosure may configure handover-related parameters, based on the determined position of the UE related to the movement direction of the satellite within the serving cell and the neighbor cell. Operation 1620 may be performed similarly to operation 840 of FIG. 8, operation 950 of FIG. 9A, operation 1030 of FIG. 10A, or operation 1120 of FIG. 11. Descriptions redundant with those provided with reference to FIG. 8, 9A, 10A, or 11 are omitted, and reference is made to FIG. 8, 9A, 10A, or 11.

According to an embodiment of the disclosure, the communication performance of the UE and the QoS of the user may be improved by allowing the UE to select optimal handover parameters for each situation by taking into account the position of the UE within the serving cell and the neighbor cell according to the movement direction of the satellites when the UE performs the handover or cell selection procedure in the NTN communication system.

However, effects to be achieved by the disclosure are not limited to those described above, and other effects that are not mentioned herein will be clearly understood from the following description by those of ordinary skill in the art.

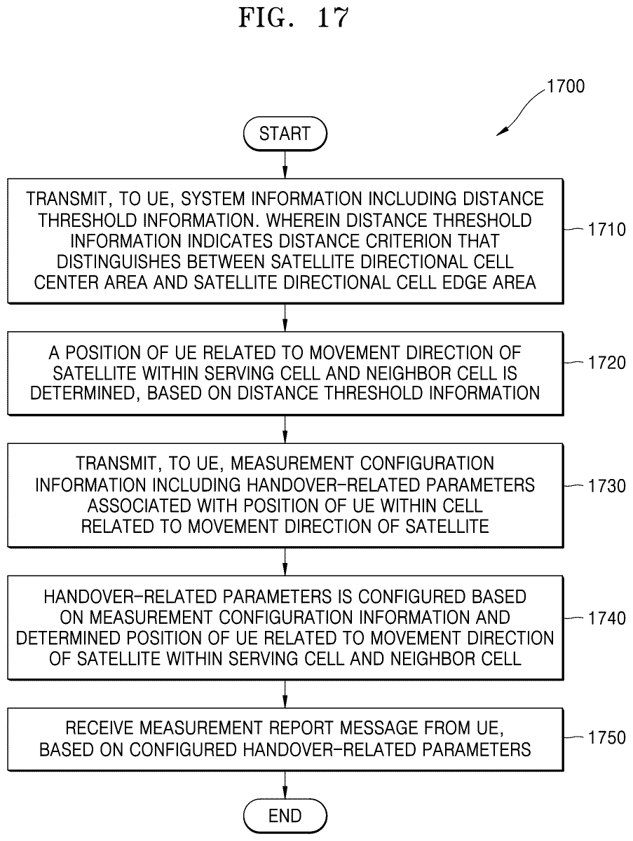

FIG. 17 is a diagram for describing a method, performed by the base station 20, of performing handover by taking into account a movement direction of a satellite in an NTN communication system according to an embodiment of the disclosure.

The definitions of a satellite directional cell center area and a satellite directional cell edge area are the same as the description provided with reference to FIG. 5A, and redundant descriptions thereof are omitted herein.

Referring to FIG. 17, in operation 1710, the base station 20 according to an embodiment of the disclosure may transmit, to the UE 10, system information including distance threshold information. The distance threshold information may indicate a distance criterion that distinguishes between the satellite directional cell center area and the satellite directional cell edge area. Operation 1710 may be performed similarly to operation 810 of FIG. 8 or operation 930 of FIG. 9A. Descriptions redundant with those provided with reference to FIG. 8 or 9A are omitted, and reference is made to FIG. 8 or 9A.

In operation 1720, the position of the UE related to the movement direction of the satellite within the serving cell and the neighbor cell may be determined based on the distance threshold information. Operation 1720 may be performed similarly to operation 830 of FIG. 8, 940 of FIG. 9A, or operation 1020 of FIG. 10A. Descriptions redundant with those provided with reference to FIG. 8, 9A, or 10A are omitted, and reference is made to FIG. 8, 9A, or 10A.

In operation 1730, the base station 20 according to an embodiment of the disclosure may transmit, to the UE 10, measurement configuration information including handover-related parameters associated with the position of the UE within the cell related to the movement direction of the satellite. Operation 1730 may be performed similarly to operation 820 of FIG. 8 or operation 1110 of FIG. 11. Descriptions redundant with those provided with reference to FIG. 8 or 11 are omitted, and reference is made to FIG. 8 or 11.

In operation 1740, handover-related parameters may be configured, based on the measurement configuration information and the determined position of the UE related to the movement direction of the satellite within the serving cell and the neighbor cell. Operation 1740 may be performed similarly to operation 840 of FIG. 8, operation 950 of FIG. 9A, operation 1030 of FIG. 10A, or operation 1120 of FIG. 11. Descriptions redundant with those provided with reference to FIG. 8, 9A, 10A, or 11 are omitted, and reference is made to FIG. 8, 9A, 10A, or 11.

In operation 1750, the base station 20 according to an embodiment of the disclosure may receive a measurement report message from the UE 10, based on the configured handover-related parameters. Operation 1750 may be performed similarly to operation 860 of FIG. 8 or operation 1130 of FIG. 11. Descriptions redundant with those provided with reference to FIG. 8 or 11 are omitted, and reference is made to FIG. 8 or 11.

According to an embodiment of the disclosure, the communication performance of the UE and the QoS of the user may be improved by allowing the base station to provide optimal handover parameters for each situation by taking into account the position of the UE within the serving cell and the neighbor cell according to the movement direction of the satellites when the handover/cell selection is performed in the NTN communication system.

However, effects to be achieved by the disclosure are not limited to those described above, and other effects that are not mentioned herein will be clearly understood from the following description by those of ordinary skill in the art.

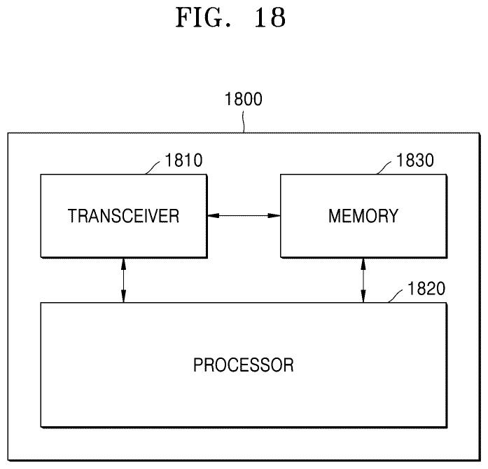

FIG. 18 is a block diagram of a UE 1800 according to an embodiment of the disclosure. The UE 1800 may correspond to the UE 10 of the disclosure.

Referring to FIG. 18, the UE 1800 may include at least one transceiver 1810, at least one processor 1820, and at least one memory 1830. The transceiver 1810, the processor 1820, and the memory 1830 of the UE 1800 may operate according to the communication method of the UE 1800 described above. However, the elements of the UE 1800 are not limited to the example described above. For example, the UE 1800 may include more elements than the elements described above or may include fewer elements than the elements described above. In an embodiment of the disclosure, the transceiver 1810, the processor 1820, and the memory 1830 may be implemented in the form of a single chip. In addition, the processor 1820 may include one or more processors.

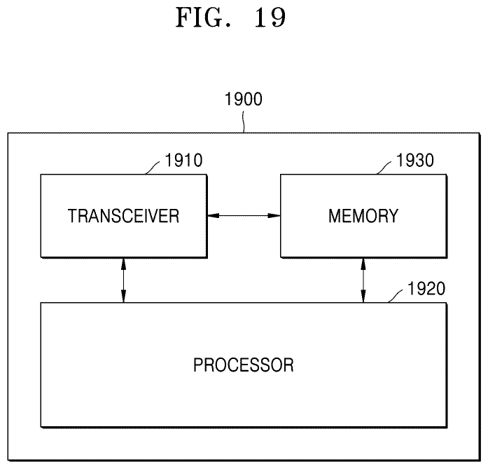

The transceiver 1810 is a general term for a receiver of the UE 1800 and a transmitter of the UE 1800, and may transmit and receive signals to and from a network entity including a base station (see 1900 of FIG. 19). Signals transmitted to and received from the network entity including the base station (see 1900 of FIG. 19) may include control information and data. To this end, the transceiver 1810 may include an RF transmitter that performs up-conversion and amplification on a frequency of a signal to be transmitted, and an RF receiver that performs low noise amplification on a received signal and performs down-conversion on a frequency of the received signal. However, this is only an example of the transceiver 1810, and the elements of the transceiver 1810 are not limited to the RF transmitter and the RF receiver.

In addition, the transceiver 1810 may perform functions of transmitting and receiving signals through a radio channel. For example, the transceiver 1810 may receive a signal through a radio channel, output the received signal to the processor 1820, and transmit an output signal of the processor 1820 through the radio channel.

The memory 1830 may store programs and data necessary for the operation of the UE 1800. In addition, the memory 1830 may store control information or data included in the signals obtained by the UE 1800. The memory 1830 may include a storage medium, such as read-only memory (ROM), random access memory (RAM), hard disk, compact disc-ROM (CD-ROM), and digital versatile disc (DVD), or any combination thereof.

Furthermore, the memory 1830 may not exist separately and may be included in the processor 1820. The memory 1830 may include volatile memory, non-volatile memory, or a combination of volatile memory and non-volatile memory. The memory 1830 may provide the stored data in response to the request of the processor 1820.

The memory 1830 may be electrically, operatively, or communicatively coupled to the processor 1820 and may be accessed by the processor 1820.

The memory 1830 may store a computer program, codes, or instructions executable by the processor 1820. According to an embodiment, a computer program, codes, or instructions executable by the processor 1820 may be either stored in a single memory device or separated and distributedly stored in two or more memory devices. By executing the instructions stored in the memory 1830, the processor 1820 may perform various functions according to an embodiment of the disclosure.

The processor 1820 may control a series of processes so that the UE 1800 is able to operate according to the above-described embodiment of the disclosure. For example, the processor 1820 may receive a control signal and a data signal through the transceiver 1810 and may process the received control signal and the received data signal. The processor 1820 may transmit the processed control signal and the processed data signal through the transceiver 1810. In addition, the processor 1820 may write data to the memory 1830 and read data from the memory 1830. The processor 1820 may perform functions of a protocol stack required in communication standards. To this end, the processor 1820 may include at least one processor or microprocessor. In an embodiment of the disclosure, a portion of the transceiver 1810 or the processor 1820 may be referred to as a communication processor (CP).

The processor 1820 may be implemented as one or more processors. In this case, one or more processors may be a generic-purpose processor, such as a CPU, an application processor (AP), or a digital signal processor (DSP), a dedicated graphics processor, such as a graphics processing unit (GPU) or a vision processing unit (VPU), or a dedicated artificial intelligence (AI) processor, such as a neural processing unit (NPU). For example, when the one or more processors are dedicated artificial intelligence processors, the dedicated artificial intelligence processors may be designed with a hardware structure specialized for processing a specific artificial intelligence model.

The processor 1820 may control general operations of the UE according to embodiments of the disclosure. The processor 1820 may be implemented by one or more integrated circuit (or circuitry) (IC) chips and may execute various data processings. The processor 1820 may include at least one electric circuit, and may execute instructions (or a program, codes, data, etc.) stored in the memory, individually, collectively or in any combination thereof. Further, the processor 1820 may include a single-core processor or multi-core processor, and may include a processor assembly including a plurality of processing circuits (circuitry) according to a specific implementation scheme.

The processor 1820 may be electrically, operatively, or communicatively coupled to the transceiver 1810 to control the transceiver 1810.

The processor 1820 may include at least one processor (or processing circuitry), and the at least one processor may perform the following operations individually, collectively or in any combination thereof. For example, the processor 1820 may include a communication processor (CP) configured to control communication operations and an application processor (AP) configured to control execution of an upper layer (for example, an application layer). In a specific embodiment, at least a part of the processor 1820 be included in one chip and the other part of the processor 1820 may be included in another chip. Otherwise, at least one processor may be included in another component, for example, the transceiver 1810 or the memory 1830.

The processor 1820 may perform or control or cause an operation of the UE for executing at least one or a combination of methods according to embodiments of the disclosure. For example, the processor 1820 may control operations of the UE for processing a downlink signal received from a BS or generating and transmitting an uplink signal to a BS. To this end, the processor 1820 may execute a computer program, codes, or instructions stored in the memory, so as to control other components of the UE to enable execution of various operations.

According to an embodiment of the disclosure, operations of the UE may be caused to be performed based on execution of instructions (or a computer program or codes) stored in the memory by at least one processor (or processing circuitry) configured to execute the same individually, collectively, or in any combination thereof, based on processing circuitry that is not configured to execute instructions, and/or based on components of processing circuitry that is not configured to execute instructions.

In an embodiment of the disclosure, the processor 1820 may determine whether a position of the UE 1800 related to a movement direction of a satellite within a serving cell and a neighbor cell is a satellite directional cell center area or a satellite directional cell edge area. The processor 1820 may configure handover-related parameters based on the determined position of the UE 1800 related to the movement direction of the satellite within the serving cell and the neighbor cell.

In an embodiment of the disclosure, the processor 1820 may obtain distance threshold information. The distance threshold information may indicate a distance criterion that distinguishes between the satellite directional cell center area and the satellite directional cell edge area. The processor 1820 may determine the position of the UE 1800 related to the movement direction of the satellite within the serving cell and the neighbor cell, based on the distance threshold information.

In an embodiment of the disclosure, the processor 1820 may obtain, from the base station (see 1900 of FIG. 19), system information including the distance threshold information. The processor 1820 may configure the distance threshold information as a value predefined in the UE 1800. The processor 1820 may obtain the distance threshold information from a server of a mobile communication service provider. The processor 1820 may obtain the distance threshold information from a server of a manufacturer of the UE 1800. The processor 1820 may obtain the distance threshold information from a core network.

In an embodiment of the disclosure, the processor 1820 may extract repetitive specific RSRP pattern information from RSRP measurement data of the serving cell and RSRP measurement data of the neighbor cell. The processor 1820 may determine the position of the UE 1800 related to the movement direction of the satellite within the serving cell and the neighbor cell, based on the extracted specific RSRP pattern information.

In an embodiment of the disclosure, the processor 1820 may receive, from the base station (see 1900 of FIG. 19), via RRC signaling, measurement configuration information, including handover-related parameters associated with the position of the UE related to the movement direction of the satellite. The processor 1820 may configure handover-related parameters based on the received measurement configuration information and the determined position of the UE 1800 related to the movement direction of the satellite within the serving cell and the neighbor cell. The processor 1820 may transmit, to the base station (see 1900 of FIG. 19), a measurement report message for handover, based on the configured handover-related parameters.

In an embodiment of the disclosure, the measurement configuration information may include event trigger configuration information. The event trigger configuration information may include a plurality of event ID information. Each of the plurality of event ID information may correspond to the position of the UE related to the movement direction of the satellite within the serving cell and the neighbor cell.

In an embodiment of the disclosure, the processor 1820 may identify specific event ID information corresponding to the determined position of the UE related to the movement direction of the satellite within the serving cell and the neighbor cell. The processor 1820 may configure handover-related parameters associated with the identified specific event ID information.

In an embodiment of the disclosure, the specific event ID information may be associated with an RSRP-based measurement report event triggering condition. The processor 1820 may determine whether the setting values of the handover-related parameters associated with the specific event ID information are satisfied, based on the RSRP measurement result of the serving cell and the RSRP measurement result of the neighbor cell. When the processor 1820 determines that the setting values are satisfied, the processor 1820 may transmit a measurement report message for handover to the base station (see 1900 of FIG. 19).

In an embodiment of the disclosure, the specific event ID information may be associated with a distance-based measurement report event triggering condition. The processor 1820 may determine whether the setting values of the handover-related parameters associated with the specific event ID information are satisfied, based on the distance between the center of the serving cell and the UE and the distance between the center of the neighbor cell and the UE. When the processor 1820 determines that the setting values are satisfied, the processor 1820 may transmit a measurement report message for handover to the base station (see 1900 of FIG. 19).

In an embodiment of the disclosure, the processor 1820 may arbitrarily change and configure the setting values of specific handover-related parameters, based on the determined position of the UE 1800 related to the movement direction of the satellite within the serving cell and the neighbor cell.

In an embodiment of the disclosure, the processor 1820 may identify that at least one of a first satellite forming the serving cell or a second satellite forming the neighbor cell has changed, based on a change in PCI or a change in satellite orbit information. The processor 1820 may re-determine whether the position of the UE 1800 related to the movement direction of the satellite within the corresponding cell of the changed satellite is the satellite directional cell center area or the satellite directional cell edge area. The processor 1820 may reconfigure the handover-related parameters, based on the determined position of the UE 1800 within the re-determined cell related to the movement direction of the satellite.

FIG. 19 is a block diagram of the base station 1900 according to an embodiment of the disclosure. The base station 1900 may correspond to a quasi-earth fixed cell formed by a satellite in an NTN communication system. The base station 1900 may correspond to the base station 20 of the disclosure.

Referring to FIG. 19, the base station 1900 may include at least one transceiver 1910, at least one processor 1920, and at least one memory 1930. The transceiver 1910, the processor 1920, and the memory 1930 of the base station 1900 may operate according to the communication method of the base station 1900 described above. However, the elements of the base station 1900 are not limited to the example described above. For example, the base station 1900 may include more elements than the elements described above or may include fewer elements than the elements described above. In an embodiment of the disclosure, the transceiver 1910, the processor 1920, and the memory 1930 may be implemented in the form of a single chip. In addition, the processor 1920 may include one or more processors.

The transceiver 1910 is a general term for a receiver of the base station 1900 and a transmitter of the base station 1900, and may transmit and receive signals to and from a network entity including the UE 1800. Signals transmitted to and received from the network entity including the UE 1800 may include control information and data. To this end, the transceiver 1910 may include an RF transmitter that performs up-conversion and amplification on a frequency of a signal to be transmitted, and an RF receiver that performs low noise amplification on a received signal and performs down-conversion on a frequency of the received signal. However, this is only an example of the transceiver 1910, and the elements of the transceiver 1910 are not limited to the RF transmitter and the RF receiver.

In addition, the transceiver 1910 may perform functions of transmitting and receiving signals through a radio channel. For example, the transceiver 1910 may receive a signal through a radio channel, output the received signal to the processor 1920, and transmit an output signal of the processor 1920 through the radio channel.

The memory 1930 may store programs and data necessary for the operation of the base station 1900. In addition, the memory 1930 may store control information or data included in the signals obtained by the base station 1900. The memory 1930 may include a storage medium, such as ROM, RAM, hard disk, CD-ROM, and DVD, or any combination thereof.

The memory 1930 may be electrically, operatively, or communicatively coupled to the processor 1920 and may be accessed by the processor 1920.

The memory 1930 may store a computer program, codes, or instructions executable by the processor 1920. According to an embodiment, a computer program, codes, or instructions executable by the processor 1920 may be either stored in a single memory device or separated and distributedly stored in two or more memory devices. By executing the instructions stored in the memory 1930, the processor 1920 may perform various functions according to an embodiment of the disclosure.

Furthermore, the memory 1930 may not exist separately and may be included in the processor 1920. The memory 1930 may include volatile memory, non-volatile memory, or a combination of volatile memory and non-volatile memory. The memory 1930 may provide the stored data in response to the request of the processor 1920.

The processor 1920 may control a series of processes so that the base station 1900 is able to operate according to the above-described embodiment of the disclosure. For example, the processor 1920 may receive a control signal and a data signal through the transceiver 1910 and may process the received control signal and the received data signal. The processor 1920 may transmit the processed control signal and the processed data signal through the transceiver 1910. In addition, the processor 1920 may write data to the memory 1930 and read data from the memory 1930. The processor 1920 may perform functions of a protocol stack required in communication standards. To this end, the processor 1920 may include at least one processor or microprocessor. In an embodiment of the disclosure, a portion of the transceiver 1910 or the processor 1920 may be referred to as a CP.

The processor 1920 may be implemented as one or more processors. In this case, one or more processors may be a generic-purpose processor, such as a CPU, an AP, or a DSP, a dedicated graphics processor, such as a GPU or a vision processing unit (VPU), or a dedicated AI processor, such as an NPU. For example, when the one or more processors are dedicated artificial intelligence processors, the dedicated artificial intelligence processors may be designed with a hardware structure specialized for processing a specific artificial intelligence model.

The processor 1920 may control general operations of the BS according to embodiments of the disclosure. The processor 1920 may be implemented by one or more integrated circuit (or circuitry) (IC) chips and may execute various data processings. The processor 1920 may include at least one electric circuit, and may execute instructions (or a program, codes, data, etc.) stored in the memory, individually, collectively or in any combination thereof. Further, the processor 1920 may include a single-core processor or multi-core processor, and may include a processor assembly including a plurality of processing circuits (circuitry) according to a specific implementation scheme.

The processor 1920 may be electrically, operatively, or communicatively coupled to the transceiver 1910 to control the transceiver 1910.

The processor 1920 may include at least one processor (or processing circuitry), and the at least one processor may perform the following operations individually, collectively or in any combination thereof. In a specific embodiment, at least a part of the processor 1920 may be included in one chip and the other part of the processor 1920 may be included in another chip. Otherwise, at least one processor may be included in another component, for example, the transceiver 1910 or the memory 1930.

The processor 1920 may perform or control or cause an operation of the BS for executing at least one or a combination of methods according to embodiments of the disclosure. For example, the processor 1920 may control operations of the BS for generating and transmitting a downlink signal to a UE or processing an uplink signal received from a UE. Otherwise, the BS may transmit or receive a signal to or from a neighboring BS, transfer a signal received from a UE to an upper node of the network, or transmit a signal transferred from an upper node of the network to a UE. To this end, the processor 1920 may execute a computer program, codes, or instructions stored in the memory, so as to control other components of the BS to enable execution of various operations.

According to an embodiment of the disclosure, operations of the BS may be caused to be performed based on execution of instructions (or a computer program or codes) stored in the memory by at least one processor (or processing circuitry) configured to execute the same individually, collectively, or in any combination thereof, based on processing circuitry that is not configured to execute instructions, and/or based on components of processing circuitry that is not configured to execute instructions.

In an embodiment of the disclosure, the processor 1920 may broadcast, to the UE 1800, system information including the distance threshold information. In an embodiment of the disclosure, the distance threshold information indicates a distance criterion that distinguishes between the satellite directional cell center area and the satellite directional cell edge area. In an embodiment of the disclosure, the position of the UE 1800 related to the movement direction of the satellite within the serving cell and the neighbor cell may be determined based on the distance threshold information.

In an embodiment of the disclosure, the processor 1920 may transmit, to the UE 1800, measurement configuration information including handover-related parameters associated with the position of the UE related to the movement direction of the satellite within the serving cell and the neighboring cell. In an embodiment of the disclosure, the handover-related parameters may be configured, based on the measurement configuration information and the determined position of the UE 1800 related to the movement direction of the satellite within the serving cell and the neighbor cell.

In an embodiment of the disclosure, the processor 1920 may receive a measurement report message for handover from the UE 1800, based on the configured handover-related parameters.

Specific examples for describing an embodiment of the disclosure is only a combination of the respective criteria, methods, detailed methods, and operations, and the base station and the UE may improve the communication performance of the UE and the QoS of the user through a combination of at least two or more techniques among various techniques during handover/cell selection in the NTN communication system. In addition, this may be performed according to a method determined through one or a combination of at least two of the techniques described above. For example, some operations of an embodiment of the disclosure may be performed in combination with some operations of an embodiment of the disclosure.

A machine-readable storage medium may be provided in the form of a non-transitory storage medium. The ‘non-transitory storage medium’ is a tangible device and only means not including a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

A method according to an embodiment of the disclosure may be provided by being included in a computer program product. The computer program product may be traded between a seller and a buyer as commodities. The computer program product may be distributed in the form of a machine-readable storage medium (e.g., CD-ROM), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

While the disclosure has been shown and described with reference to various embodiments thereof, it will be understood by those skilled in the art that various changes in form and details may be made therein without departing from the spirit and scope of the disclosure as defined by the appended claims and their equivalents.

Meanwhile, although specific embodiments of the present disclosure have been described in detail, various modifications may be made without departing from the scope of the present disclosure. Therefore, the scope of the present disclosure should not be limited to the described embodiments, but should be defined by the claims and equivalents thereof.

What is claimed is:

1. A method performed by a user equipment (UE) in a non-terrestrial network (NTN) system, the method comprising:
determining whether a position of the UE related to a movement direction of a satellite within a serving cell and a neighbor cell is a satellite directional cell center area or a satellite directional cell edge area; and
configuring handover-related parameters, based on the determined position of the UE related to the movement direction of the satellite within the serving cell and the neighbor cell.

2. The method of claim 1, further comprising:
obtaining distance threshold information, the distance threshold information indicating a distance criterion that distinguishes between the satellite directional cell center area and the satellite directional cell edge area; and
determining the position of the UE related to the movement direction of the satellite within the serving cell and the neighbor cell, based on the distance threshold information.

3. The method of claim 2, wherein the obtaining of the distance threshold information comprises at least one of:
obtaining, from a base station, system information including the distance threshold information;
configuring the distance threshold information as a value predefined in the UE;
obtaining the distance threshold information from a server of a mobile communication service provider;
obtaining the distance threshold information from a server of a manufacturer of the UE; or
obtaining the distance threshold information from a core network.

4. The method of claim 1, further comprising:
extracting repetitive specific reference signal received power (RSRP) pattern information from RSRP measurement data of the serving cell and RSRP measurement data of the neighbor cell; and
determining the position of the UE related to the movement direction of the satellite within the serving cell and the neighbor cell, based on the extracted specific RSRP pattern information.

5. The method of claim 1, further comprising:
receiving, from a base station, via radio resource control (RRC) signaling, measurement configuration information including the handover-related parameters associated with the position of the UE related to the movement direction of the satellite;
configuring the handover-related parameters, based on the received measurement configuration information and the determined position of the UE related to the movement direction of the satellite within the serving cell and the neighbor cell; and
transmitting a measurement report message for handover to the base station, based on the configured handover-related parameters.

6. The method of claim 5,
wherein the measurement configuration information includes event trigger configuration information,
wherein the event trigger configuration information includes a plurality of event identifier (ID) information,
wherein each of the plurality of event ID information corresponds to each position of the UE related to the movement direction of the satellite within the serving cell and the neighbor cell, and
wherein the method further comprises:
identifying specific event ID information corresponding to the determined position of the UE related to the movement direction of the satellite within the serving cell and the neighbor cell, and
configurating handover-related parameters associated with the identified specific event ID information.

7. The method of claim 6,
wherein the specific event ID information is associated with an RSRP-based measurement report event triggering condition, and
wherein the method further comprises:
determining whether setting values of the handover-related parameters associated with the specific event ID information are satisfied, based on an RSRP measurement result of the serving cell and an RSRP measurement result of the neighbor cell; and
when it is determined that the setting values are satisfied, transmitting the measurement report message for handover to the base station.

8. The method of claim 6,
wherein the specific event ID information is associated with distance-based measurement report event triggering condition, and
wherein the method further comprises:
determining whether setting values of the handover-related parameters associated with the specific event ID information are satisfied, based on a distance between a center of the serving cell and the UE and a distance between a center of the neighbor cell and the UE; and
when it is determined that the setting values are satisfied, transmitting the measurement report message for handover to the base station.

9. The method of claim 1, further comprising arbitrarily changing and configuring setting values of specific handover-related parameters, based on the determined position of the UE related to the movement direction of the satellite within the serving cell and the neighbor cell.

10. The method of claim 1, further comprising:
identifying that at least one of a first satellite forming the serving cell or a second satellite forming the neighbor cell has changed, based on a change in physical cell ID (PCI) or a change in satellite orbit information;
re-determining whether the position of the UE related to the movement direction of the satellite within a corresponding cell of the changed satellite is the satellite directional cell center area or the satellite directional cell edge area; and
reconfiguring the handover-related parameters, based on the re-determined position of the UE related to the movement direction of the satellite within the corresponding cell.

11. A method performed by a base station in a non-terrestrial network (NTN) system, the method comprising:
broadcasting, to a user equipment (UE), system information including distance threshold information, wherein the distance threshold information indicates a distance criterion that distinguishes between a satellite directional cell center area and a satellite directional cell edge area, and a position of the UE related to a movement direction of a satellite within a serving cell and a neighbor cell is determined, based on the distance threshold information;
transmitting, to the UE, measurement configuration information including handover-related parameters associated with the position of the UE related to the movement direction of the satellite within the serving cell and the neighbor cell, wherein the handover-related parameters are configured, based on the measurement configuration information and the determined position of the UE related to the movement direction of the satellite within the serving cell and the neighbor cell; and
receiving a measurement report message from the UE, based on the configured handover-related parameters.

12. A user equipment (UE) in a non-terrestrial network (NTN) system, the UE comprising:
memory storing one or more instructions; and
at least one processor communicatively coupled to the memory,
wherein the one or more instructions, when executed by the at least one processor individually or collectively, cause the UE to:
determine whether a position of the UE related to a movement direction of a satellite within a serving cell and a neighbor cell is a satellite directional cell center area or a satellite directional cell edge area, and
configure handover-related parameters, based on the determined position of the UE related to the movement direction of the satellite within the serving cell and the neighbor cell.

13. The UE of claim 12, wherein the one or more instructions, when executed by the at least one processor individually or collectively, further cause the UE to:
obtain distance threshold information, wherein the distance threshold information indicates a distance criterion that distinguishes between the satellite directional cell center area and the satellite directional cell edge area; and
determine the position of the UE related to the movement direction of the satellite within the serving cell and the neighbor cell, based on the distance threshold information.

14. The UE of claim 13, wherein the one or more instructions, when executed by the at least one processor individually or collectively, further cause the UE to:
obtain, from a base station, system information including the distance threshold information,
configure the distance threshold information as a value predefined in the UE,
obtain the distance threshold information from a server of a mobile communication service provider,
obtain the distance threshold information from a server of a manufacturer of the UE, or
obtain the distance threshold information from a core network.

15. The UE of claim 12, wherein the one or more instructions, when executed by the at least one processor individually or collectively, further cause the UE to:
extract repetitive specific reference signal received power (RSRP) pattern information from RSRP measurement data of the serving cell and RSRP measurement data of the neighbor cell; and
determine the position of the UE related to the movement direction of the satellite within the serving cell and the neighbor cell, based on the extracted specific RSRP pattern information.

16. The UE of claim 12, wherein the one or more instructions, when executed by the at least one processor individually or collectively, further cause the UE to:
receive, from a base station, via radio resource control (RRC) signaling, measurement configuration information including the handover-related parameters associated with the position of the UE related to the movement direction of the satellite;
configure the handover-related parameters, based on the received measurement configuration information and the determined position of the UE related to the movement direction of the satellite within the serving cell and the neighbor cell; and
transmit a measurement report message for handover to the base station, based on the configured handover-related parameters.

17. The UE of claim 16,
wherein the measurement configuration information includes event trigger configuration information,
wherein the event trigger configuration information includes a plurality of event identifier (ID) information,
wherein each of the plurality of event ID information corresponds to each position of the UE related to the movement direction of the satellite within the serving cell and the neighbor cell, and
wherein the one or more instructions, when executed by the at least one processor individually or collectively, further cause the UE to:
identify specific event ID information corresponding to the determined position of the UE related to the movement direction of the satellite within the serving cell and the neighbor cell, and
configure handover-related parameters associated with the identified specific event ID information.

18. The UE of claim 17,
wherein the specific event ID information is associated with an RSRP-based measurement report event triggering condition, and
wherein the one or more instructions, when executed by the at least one processor individually or collectively, further cause the UE to:
determine whether setting values of the handover-related parameters associated with the specific event ID information are satisfied, based on an RSRP measurement result of the serving cell and an RSRP measurement result of the neighbor cell, and
when it is determined that the setting values are satisfied, transmit the measurement report message for handover to the base station.

19. The UE of claim 17,
wherein the specific event ID information is associated with distance-based measurement report event triggering condition, and
wherein the one or more instructions, when executed by the at least one processor individually or collectively, further cause the UE to:
determine whether setting values of the handover-related parameters associated with the specific event ID information are satisfied, based on a distance between a center of the serving cell and the UE and a distance between a center of the neighbor cell and the UE, and
when it is determined that the setting values are satisfied, transmit the measurement report message for handover to the base station.

20. A base station in a non-terrestrial network (NTN) system, the base station comprising:
memory storing one or more instructions; and
at least one processor communicatively coupled to the memory,
wherein the one or more instructions, when executed by the at least one processor individually or collectively, cause the base station to:
broadcast, to a user equipment (UE), system information including distance threshold information, wherein the distance threshold information indicates a distance criterion that distinguishes between a satellite directional cell center area and a satellite directional cell edge area, and a position of the UE related to a movement direction of a satellite within a serving cell and a neighbor cell is determined, based on the distance threshold information,
transmit, to the UE, measurement configuration information including handover-related parameters associated with the position of the UE related to the movement direction of the satellite within the serving cell and the neighbor cell, wherein the handover-related parameters are configured, based on the measurement configuration information and the determined position of the UE related to the movement direction of the satellite within the serving cell and the neighbor cell, and
receive a measurement report message from the UE, based on the configured handover-related parameters.
